(19) United States
(12) Patent Application Publication
(10) Pub. No.: US 2020/0216126 A1
(43) Pub. Date: Jul. 9, 2020

(54) CONTROL SYSTEMS FOR HEAVY LOAD WALKING SYSTEMS

(71) Applicant: HYDRAULIC SYSTEMS, LLC, THE WOODLANDS, TX (US)

(72) Inventors: CARL FLYNT HIGGINBOTHAM, III, ROMAN FOREST, TX (US); MICHAEL EDWARD URDIALES, MONTGOMERY, TX (US); BRADLEY ALLEN LITTLE, CYPRESS, TX (US); RYAN D INDERWIESEN, CYPRESS, TX (US); BRETT SAATHOFF, KINGWOOD, TX (US)

(73) Assignee: HYDRAULIC SYSTEMS, LLC, THE WOODLANDS, TX (US)

(21) Appl. No.: 16/596,740

(22) Filed: Oct. 8, 2019

Related U.S. Application Data
(63) Continuation-in-part of application No. 16/591,582, filed on Oct. 2, 2019.
(60) Provisional application No. 62/742,743, filed on Oct. 8, 2018.

(51) Int. Cl. B62D 57/02; B62D 57/032; B60K 35/00

(52) U.S. Cl. CPC B62D 57/022; B62D 57/032; B60K 2370/586; B60K 2370/55; B60K 35/00

(57) ABSTRACT

A portable master control unit for a load transporting system configured to be removed from the load to eliminate damage to the control unit and cables when the load is in position.

### CROSS REFERENCE TO RELATED APPLICATIONS

This application claims benefit of and priority to U.S. patent application Ser. No. 16/591,582, entitled Walking Systems for Heavy Load and Controls Therefor filed on Oct. 2, 2019, and U.S. Provisional Patent Application No. 62/742,743, entitled Lifting Control Systems and Methods of Use filed on Oct. 8, 2018, the entire contents of both of which are incorporated herein by reference for all purposes.

### STATEMENT REGARDING FEDERALLY SPONSORED RESEARCH OR DEVELOPMENT

Not applicable.

### REFERENCE TO APPENDIX

Not applicable.

### BACKGROUND OF THE INVENTION

### Field of the Invention

The present inventions relate to apparatuses for transporting a load, and more particularly relate to methods and systems for controlling ambulation of heavy loads with the ability to steer the load.

### Description of the Related Art

For heavy loads that need periodic movement or adjustment of position, transportation systems commonly referred to as “walking machines” or “walkers” were developed. Walking machines are particularly useful for moving large, heavy structures, such as oil rigs, silos, and the like.

Walking machines typically use hydraulic lift cylinders as motors to lift the load above a supporting surface, such as the ground, and then displace or translate the load in a desired direction by sliding or rolling movement related to the stroke of the hydraulic cylinder.

For example, U.S. Pat. No. 8,925,658, discloses “a drill rig relocation system. Lift frames are provided at opposite ends of a base box of a drill rig substructure. A lift cylinder and bearing mat assembly are rotatably connected beneath the lift frame. The bearing mat assemblies may be rotated to the desired direction for moving the drill rig. The lift cylinders are then expanded, placing the bearing mat assemblies onto the ground and lifting the base boxes and drill rig off the ground. The drill rig is supported on linear sleeve bearings slidably mounted in the bearing mat assemblies. Translation cylinders on the bearing mats expanded to move the rig by translating the linear sleeve bearings along the shafts. After the lift cylinder expands to place the bearing mat on the ground, the translation cylinders are retracted, providing the linear bearing with the full length of the shaft for the next movement.

U.S. Pat. No. 9,751,578, discloses “A load transporting apparatus includes a base structure that supports a load and a plurality of transport devices that move the base structure over a base surface. A first group of transport devices concurrently contact the base surface during a first movement step. Following the first movement step the first group of transport devices are disengaged from the base structure during a second movement step of the base structure. A second group of transport devices are disengaged from the base surface during the first movement step. Following the first movement step the second group of transport devices contact the base surface during the second movement step, and the weight of the load supported by the first group of transport devices is transferred from the first group of transport devices to the second group of transport devices.”

U.S. Pat. No. 10,308,299, owned by Applicant, discloses “A load transporting apparatus may be steered while transporting a load across a base surface, and the load transporting apparatus may be operated hydraulically, electrically, or by use of an encoder. In particular, the load transporting apparatus may include a track configured to a saddle housing (a support movement for a movement assembly), and a foot that may be connected to the track. During load transport, the pad saver may be maintained in a substantially similar position relative to a frame structure supporting the load, even when the transport movement is not in a parallel direction to the orientation of the pad saver.”

The present inventions are directed to improvements in walking machines and the control systems therefor.

### BRIEF SUMMARY OF THE INVENTION

A brief non-limiting summary of one of the many possible embodiments of the present invention is a control system for multiple load transporting apparatuses each having a plurality of walking systems, comprising a master control unit comprising signal processing and logic control circuits, and a plurality of bi-directional connectors operatively coupled thereto, the control unit operationally configured to select the number of active connectors for use with a load transporting apparatus; a number of electrical cables corresponding to the number of active connectors, each cable configured to operatively connect the control unit to an associated junction box permanently associated with the load transporting apparatus; the master control unit operationally configured to receive sensor signals from the plurality of walking systems, to provide control signals to the plurality of walking systems, and to provide power to the plurality of walking systems, across the number of cables; the number of cables configured to be unconnected from the associated junction boxes when the load has been moved to the desired position, and the master control moved away from the load transporting apparatus to thereby eliminate the possibility of damage to the control unit and cables and to remove power from the plurality of walking systems. The master control unit is portable and can be transported from one load transporting apparatus to another load transporting apparatus. The master control unit operatively connected to the load transporting apparatus only when the load is being moved. The master control unit comprises 6 bi-directional connectors. The master control unit selects 2 active bi-directional connectors and 2 electrical cables operatively connect the master control unit to a load transporting apparatus. The master control unit selects 4 active bi-directional connectors and 4 electrical cables operatively connect the master control unit to a load transporting apparatus. The master control unit selects 6 active bi-directional connectors and 6 electrical cables operatively connect the master control unit to a load transporting apparatus.

Another brief non-limiting summary of one of the many possible embodiments of the present invention is a control system for a load transporting apparatus having a plurality of walking systems, comprising a master control unit comprising signal processing and logic control circuits, and a bi-directional wireless transceiver operationally configured to communicate with a number of bi-directional wireless transceivers operatively associated with the load transporting apparatus; the master control unit operationally configured to wirelessly receive sensor signals about the plurality of walking systems from the bi-directional wireless transceivers, and to provide wireless control signals for the plurality of walking systems through the bi-directional wireless transceivers. The master control unit is permanently attached to the load transporting apparatus. The master control unit is portable and not permanently attached to the load transporting apparatus. The master control unit is portable and is physically attached to the load transporting apparatus only when the load transporting system is used to move the load. Each of the plurality of walking systems has operatively associated therewith at least one junction box permanently attached to the load transporting apparatus, and a bi-directional wireless transceiver is operatively connected to the at least one junction box when it is desired to move the load. Each of bi-directional wireless transceiver has its own power supply. The master control unit and bi-directional wireless transceivers are portable and are operatively connected to the load transporting apparatus only when load is being moved.

None of these brief summaries of the inventions is intended to limit or otherwise affect the scope of the appended claims, and nothing stated in this Brief Summary of the Invention is intended as a definition of a claim term or phrase or as a disavowal or disclaimer of claim scope.

### BRIEF DESCRIPTION OF THE SEVERAL VIEWS OF THE DRAWINGS

The following figures form part of the present specification and are included to demonstrate further certain aspects of the present invention. The invention may be better understood by reference to one or more of these figures in combination with the detailed description of specific embodiments presented herein.

FIG. 1 illustrates an isometric view of one of many possible embodiments of a walking system according to the inventions disclosed herein.

FIGS. 2A-2B illustrate the system of FIG. 1 in retracted and extended states.

FIG. 3 illustrates a representative flow diagram for operating a walking system according to one or more of the present inventions.

FIG. 4 illustrates a cross-sectional view of the system in FIG. 1.

FIG. 5 illustrates an embodiment of a rotary interface suitable for use with the present inventions.

FIGS. 6A and 6B illustrate an embodiment of a translation assembly suitable for use with the present inventions.

FIGS. 7A-7D illustrate a tracked roller system suitable for use with the present inventions.

FIG. 8 illustrates an embodiment of a walking system operatively coupled to a load substructure.

FIGS. 9A-9B illustrate control circuits and equipment on a load substructure having four walking machines.

FIGS. 10A-10B illustrate control circuits and equipment on a load substructure having four walking machines and a portable master control unit.

FIGS. 11-12 illustrate preferred junction boxes suitable for use with the present inventions.

FIG. 13 illustrate an embodiment of a modular junction box system suitable for use with the present inventions.

FIG. 14 illustrates a walking system deployed in load substructure and configured for a portable master control unit.

FIG. 15 illustrates a preferred implementation of a portable master control unit.

FIGS. 16A-16D illustrate various embodiments of possible portable master control units.

FIGS. 17 and 18A illustrate control links for possible portable master control units.

FIG. 18B illustrate control circuits and equipment on a load substructure having four walking machines and a portable master control unit.

FIG. 18C illustrate control circuits and equipment on a load substructure having four walking machines and a wireless portable master control unit.

FIG. 19 illustrates and initial setup routine for a portable master control unit.

FIG. 20 illustrates an initial set up routine for a portable master control system with load ID.

FIG. 21 illustrate a walking system substructure suitable to retrofit an existing non-walking load or to be integrated into a new build having step windows.

FIGS. 22A-22E illustrate an alternate embodiment of a walking system substructure comprising retractable outriggers and a tracker roller system.

FIGS. 23-24 illustrates a walking system substructure suitable to retrofit a non-walking B Class drilling rig having a mud boat.

While the inventions disclosed herein are susceptible to various modifications and alternative forms, only a few specific embodiments have been shown by way of example in the drawings and are described in detail below. The figures and detailed descriptions of these specific embodiments are not intended to limit the breadth or scope of the inventive concepts or the appended claims in any manner. Rather, the figures and detailed written descriptions are provided to illustrate the inventive concepts to a person of ordinary skill in the art and to enable such person to make and use the inventive concepts.

### DETAILED DESCRIPTION

The Figures described above, and the written description of specific structures and functions below are not presented to limit the scope of what I have invented or the scope of the appended claims. Rather, the Figures and written description are provided to teach any person skilled in the art to make and use the inventions for which patent protection is sought. Those skilled in the art will appreciate that not all features of a commercial embodiment of the inventions are described or shown for the sake of clarity and understanding. Persons of skill in this art will also appreciate that the development of an actual commercial embodiment incorporating aspects of the present inventions will require numerous implementation-specific decisions to achieve the developer's ultimate goal for the commercial embodiment. Such implementation-specific decisions may include, and likely are not limited to, compliance with system-related, business-related, government-related, and other constraints, which may vary by specific implementation, location and from time to time. While a developer's efforts might be complex and time-consuming in an absolute sense, such efforts would be, nevertheless, a routine undertaking for those of skill in this art having benefit of this disclosure. It must be understood that the inventions disclosed and taught herein are susceptible to numerous and various modifications and alternative forms. Lastly, the use of a singular term, such as, but not limited to, “a,” is not intended as limiting of the number of items. Also, the use of relational terms, such as, but not limited to, “top,” “bottom,” “left,” “right,” “upper,” “lower,” “down,” “up,” “side,” and the like are used in the written description for clarity in specific reference to the Figures and are not intended to limit the scope of the invention or the appended claims.

Aspects of the inventions disclosed herein may be embodied as an apparatus, system, method, or computer program product. Accordingly, specific embodiments may take the form of an entirely hardware embodiment, an entirely software embodiment or an embodiment combining software and hardware aspects, such as a “circuit,” “module” or “system.” Furthermore, embodiments of the present inventions may take the form of a computer program product embodied in one or more computer readable storage media having computer readable program code.

Items, components, functions, or structures in this disclosure may be described or labeled as a “module” or “modules.” For example, but not limitation, a module may be configured as a hardware circuit comprising custom VLSI circuits or gate arrays, off-the-shelf semiconductors such as logic chips, transistors, or other discrete components. A module also may be implemented as programmable hardware devices such as field programmable gate arrays, programmable array logic, programmable logic devices, or the like. Modules also may be configured as software for execution by various types of processors. A module of executable code may comprise one or more physical or logical blocks of computer instructions that may be organized as an object, procedure, or function. The executables of a module need not be physically located together but may comprise disparate instructions stored in different locations that when joined logically together, comprise the module and achieve the stated purpose or function. A module of executable code may be a single instruction, or many instructions, and may even be distributed over several different code segments, among different programs, and across several memory devices. Similarly, data may be identified and illustrated herein within modules, and may be embodied in any suitable form and organized within any suitable type of data structure. The data may be collected as a single dataset or may be distributed over different locations including over different storage devices, and may exist, at least partially, merely as electronic signals on a system or network. Where a module or portions of a module are implemented in software, the software portions may be stored on one or more computer readable storage media.

When implementing one or more of the inventions disclosed herein, any combination of one or more computer readable storage media may be used. A computer readable storage medium may be, for example, but not limitation, an electronic, magnetic, optical, electromagnetic, infrared, or semiconductor system, apparatus, or device, or any suitable combination of the foregoing. More specific, but non-limiting, examples of the computer readable storage medium may include the following: a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), a Blu-ray disc, an optical storage device, a magnetic tape, a Bernoulli drive, a magnetic disk, a magnetic storage device, a punch card, integrated circuits, other digital processing apparatus memory devices, or any suitable combination of the foregoing, but would not include propagating signals. In the context of this disclosure, a computer readable storage medium may be any tangible medium that can contain or store a program for use by or in connection with an instruction execution system, apparatus, or device.

Computer program code for carrying out operations of one or more of the present inventions may be written in any combination of one or more programming languages, including an object oriented programming language such as Java, Python, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. The remote computer may be connected to the user's computer through any type of network, including a local area network (LAN) or a wide area network (WAN), or the connection may be made to an exterior computer for example, through the Internet using an Internet Service Provider.

Reference throughout this disclosure to “one embodiment,” “an embodiment,” or similar language means that a particular feature, structure, or characteristic described in connection with the embodiment is included in at least one of the many possible embodiments of the present inventions. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, structures, or characteristics of one embodiment may be combined in any suitable manner in one or more other embodiments. In the following description, numerous specific details are provided, such as examples of programming, software modules, user selections, network transactions, database queries, database structures, hardware modules, hardware circuits, hardware chips, etc., to provide a thorough understanding of embodiments of the disclosure. Those of skill in the art having the benefit of this disclosure will understand that the inventions may be practiced without one or more of the specific details, or with other methods, components, materials, and so forth. In other instances, well-known structures, materials, or operations are not shown or described in detail to avoid obscuring aspects of the disclosure.

Aspects of the present disclosure are described below with reference to schematic flowchart diagrams and/or schematic block diagrams of methods, apparatuses, systems, and computer program products according to embodiments of the disclosure. It will be understood by those of skill in the art that each block of the schematic flowchart diagrams and/or schematic block diagrams, and combinations of blocks in the schematic flowchart diagrams and/or schematic block diagrams, may be implemented by computer program instructions. Such computer program instructions may be provided to a processor of a general purpose computer, special purpose computer, or other programmable data processing apparatus to create a machine or device, such that the instructions, which execute via the processor of the computer or other programmable data processing apparatus, structurally configured implement the functions/acts specified in the schematic flowchart diagrams and/or schematic block diagrams block or blocks. These computer program instructions also may be stored in a computer readable storage medium that can direct a computer, other programmable data processing apparatus, or other devices to function in a particular manner, such that the instructions stored in the computer readable storage medium produce an article of manufacture including instructions which implement the function/act specified in the schematic flowchart diagrams and/or schematic block diagrams block or blocks. The computer program instructions also may be loaded onto a computer, other programmable data processing apparatus, or other devices to cause a series of operational steps to be performed on the computer, other programmable apparatus or other devices to produce a computer implemented process such that the instructions that execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and/or operation of possible apparatuses, systems, methods, and computer program products according to various embodiments of the present inventions. In this regard, each block in the schematic flowchart diagrams and/or schematic block diagrams may represent a module, segment, or portion of code, which comprises one or more executable instructions for implementing the specified logical function(s).

It also should be noted that, in some possible embodiments, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures.

Although various arrow types and line types may be employed in the flowchart and/or block diagrams, they do not limit the scope of the corresponding embodiments. Indeed, some arrows or other connectors may be used to indicate only the logical flow of the depicted embodiment. For example, but not limitation, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, may be implemented by special purpose hardware-based systems that perform the specified functions or acts, or combinations of special purpose hardware and computer instructions.

The description of elements in each Figure may refer to elements of proceeding Figures. Like numbers refer to like elements in all figures, including alternate embodiments of like elements. In some possible embodiments, the functions/actions/structures noted in the figures may occur out of the order noted in the block diagrams and/or operational illustrations. For example, two operations shown as occurring in succession, in fact, may be executed substantially concurrently or the operations may be executed in the reverse order, depending upon the functionality/acts/structure involved.

For purposes of this disclosure, the term “load” will refer to the structure or assembly that is desired to be moved from one location to another. A load may comprise, for example, an oil well drilling rig. The terms, “walker,” “walking machine,” “walking device,” and “walking system” are used interchangeably below and refer to an individual lifting and translation device and to a collection of individual lifting and translation devices. Walking systems may incorporate one or more components or subassemblies, depending on the specific configuration of the walking system. A “Load transporting apparatus” or system comprises at least one walking systems and typically comprises four walking systems but may comprise more or less.

Non-limiting feedback mechanisms to and from a walking system can be in the form of encoders, proximity sensors, magnetic pick-ups, switches, potentiometers, transducers, accelerometers, inclinometers, GPS, ultrasonic, infrared, optical, and other such devices. Non-limiting signals used in communication with the walking machine may be in milliampers, voltage, can-bus protocols, profibus protocols profinet protocols, SSI, industrial Ethernet, other similar methods, and combinations thereof. Remote controls and remotely activated, monitored, or controlled devices can use any combination of the above items if needed, and the signals may be transmitted via broad spectrum, fixed frequency, WIFI, Bluetooth, other conventional wireless radio transmission protocols, and combinations thereof. A remote control may be wired or wireless, as long as it may communicate with the load transporting apparatus. Such walking assemblies may allow for better safety of workers around drilling rigs because such workers are no longer having to manually rotate the rotational devices to move the load with the walking assembly.

The present inventions comprise sensors to read loads, position, pressures, distance, and velocity to ensure that loads are both lifted and transported in a level manner, which enhances safety. These inventions also make it both more simple and faster to transport a heavy load from one location or position to another. We have designed structures and systems that take into account lift pressures, lift displacement, translation displacements and predicted positions of the walking systems as well as the load being transported. These systems are capable of measuring moments, angles, velocity, trajectory, load analysis and many more features. The systems are also able to autocorrect when a load transporting apparatus may get out of orientation during a walk, for instance in an incline where two feet are moving at an intended orientation and velocity yet two others, upon a radial incline with a different vector may realize a loss is translation. When moving a load if the center of gravity (COG) were to change outside of prescribe boundaries the systems are able to auto correct by correction of input and/or output values. Furthermore, when beginning a step sequence, the systems are capable of displacing each lift mechanism into a state where desired resistance (e.g., preload) is required and reset the lift origin of each measuring device. Preload may be achieved by evaluation of feedback including displacement and pressure transducers as well as inclinometers and accelerometers. A gravitometer may be of benefit in such application when geographic elevations exceed one-thousand feet. Pressure transducers and displacement transducers enable, step by step, to ensure that prior to any lifting a load above the load bearing surface that all walking systems are firmly in place with adequate support beneath, at which point origin or zero values may be set, temporarily and per step, for each walking system. Lift or lateral movement may then begin. If during a lift or transport any anomaly in pressures, distance, moment, or otherwise is detected, the systems are capable of automatically implementing measures to correct. These may include pausing lift or translation cylinders that are within tolerance and correction the device(s) out of range or the inverse. This may also include setting the device down in a safe state, sending an alarm or signal to correction, and then later, after correction, reprocessing.

Aside of the aforementioned improvement and benefits to walking systems, these inventions also improve the overall speed and target realization of walking systems. These systems, capable of setting origin (or zero points), are able to minimize the work required to get safely from initial point of origin to the target destination. During a transport or walk phase, the systems are equipped to monitor, realize, and target the lowest level set-point at which it must elevate the load structure above the base surface. It is also able to realize and use the minimum distance required to lift the feet above the surface for next step, home, or directional adjustment application. These items are great improvements over manual, semi-automated and other apparatuses that cannot or do not evaluate and correct based upon the physical elements available to evaluate and use for the sake of the expediency.

The systems are able to monitor and self-correct directional or angular misdirection maintaining course and saving operator time and process. The systems are capable of moving to the correct distance in a lateral direction to achieve its intended target without the need for an operator or aid to be required to watch and translate movements, locations, and hazard.

These inventions are able to perform each of the forgoing processes in a unified approach. It is able to perform and repeat without requiring the operator to do or perform more than one step. The systems reduce the possibility of damage and loss and improves efficiency and delivers products from one location to another better, safer, and faster than conventional systems.

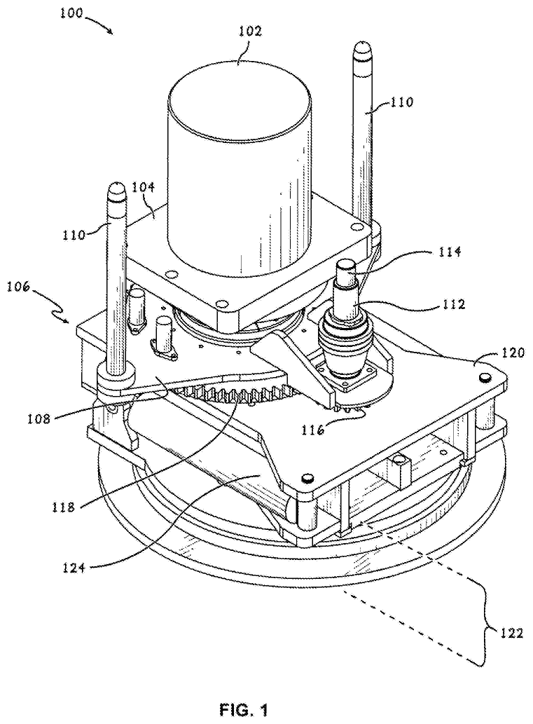

Now turning to the Figures, FIG. 1 is an isometric view of a non-limiting embodiment of a walking machine 100. The walking machine 100 is configured to lift and move a load (not shown) over a surface in one or more incremental steps. The walking machine 100 may include a lift motor 102 associated with a lift frame 104 configured to react the forces encountered when lifting the load. The machine 100 also may comprise an origin or orientation reference system 106, preferably comprising an origin frame 108 and at least one origin stabilizer 110. A rotation motor 112, preferably with a rotary position encoder 114 may be couple to the origin frame 108 as illustrated. A drive gear 116 may be operably coupled to the rotation motor 112, and mesh with a driven ring gear 118 that is coupled to a translation housing 120. A foot 122 may be coupled to the underside of the translation housing 120, and a translation motor 124 coupled between the translation housing 120 and foot 122 to establish a retracted foot position and an extended foot position.

In a non-limiting embodiment, the rotation motor 112 may have an encoder (feedback) configured to be included in the motor or otherwise connectable to the motor 112 for auto-walking the load transport system. In other embodiments, the rotation motor 112 may have no feedback or position encoder. In yet another non-limiting embodiment, the walking system 100 does not have a rotation motor 112 or encoder/feedback. In the latter instance, the walking system 100 may operate with only with only a lift motor 102. The directional orientation of the walking system 100 may be manually supplied by applying a manual force to the pinion gear 116 against the geared ring 118.

The walking system 100 may support a load of as much as 400,000 pounds to about 600,000 pounds or more. The diameter of the foot 122 may be considered the diameter of the walking system 100. The foot 122 may be divided into a multi-pieced foot for easier transport and/or for reducing costs. As a non-limiting example, the foot 122 depicted in FIG. 1 comprises three pieces; however, a foot 122 may comprise from one to as many components needed to support the load.

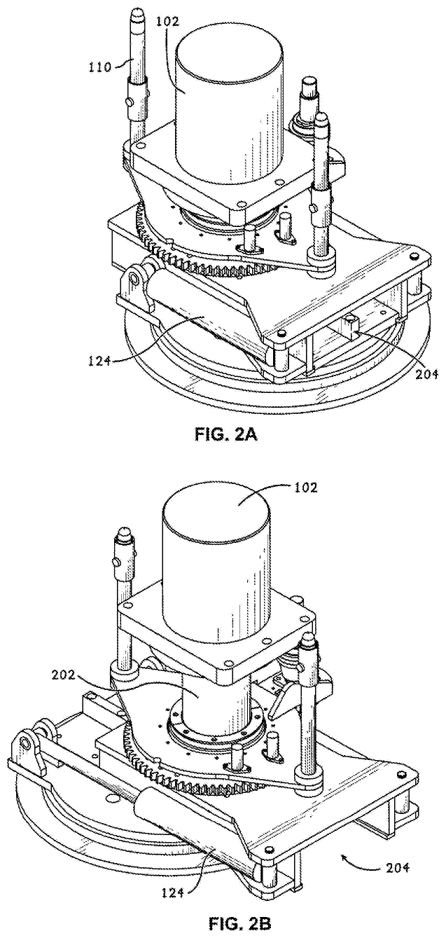

FIG. 2A is an isometric view of the walking system 100 where the translation motor 124 is in a retracted state, and the lift motor 102 is in a retracted state. It will be appreciated that when the lift motor 102 is retracted, the foot 122 does not contact the ground and the load is resting or bearing on the ground or other surface.

To move the load in a predetermined direction, while the lift motor 102 is retracted, the rotation motor 122 turns the ring gear 118 to the correct orientation, and the translation motor extends the foot in the direction of travel. The load can now be lifted by extending the lift motor 102.

FIG. 2B is an isometric view of the walking system 100 where the translation motor 124 is in the extended state. In addition, the lift motor 102 is in an extended state, which exposes the piston 202. In this condition, the load is raised from the surface and its weight is borne by the walking system 100. The load can now be moved in the direction of travel by retracting the translation motors 124, which causes the translation assembly 204 to move relative to the foot 124

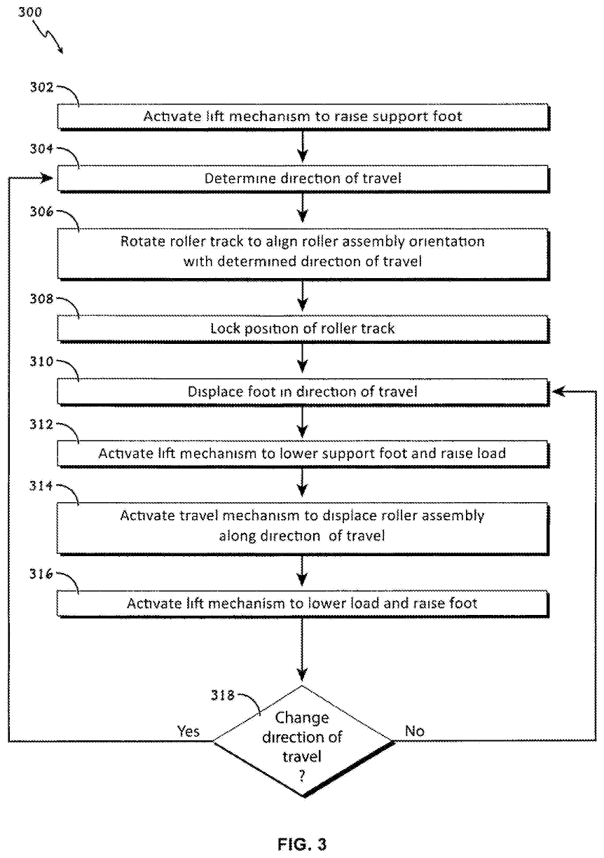

FIG. 3 is a flow diagram illustrating one of many possible processes for operating a walking apparatus according to embodiments of the invention. A process 300 may begin with activating a lift motor 302 to raise the support foot from engagement with the ground. Once raised, a direction of travel 304 may be determined. The translation assembly may then be rotated 306, such as by activating a rotation motor, to align the stroke of the translation motors with the determined direction of travel. The orientation of translation assembly may be locked 308 relative to the load, such as by activating a rotary interlock. The foot may be displaced or extended in the direction of travel 310, such as by activating the translation motors. In step 312, the lift motor 102 may be activated to extend or lower the support foot to the ground thereby lifting the load from the ground. Once the load is lifted from the ground, the load may be walked by activating the translation motors to retract thereby moving the load toward the foot and in the direction of desired travel. Once the load has translated position, the lift motor may be activated to retract the foot thereby lowering load to the ground. It may then be determined 318 if the direction of travel needs to be changed and/or whether the movement needs to be altered for the next translation or walk. If the direction and/or movement does not need to be changed, flow returns to step 310 where the retracted foot is again displaced in the direction in travel. Alternatively, when it is determined 318 that the direction of travel and/or the type of movement needs to be changed flow returns to step 304 where the new direction of travel and/or type of movement is determined.

In a non-limiting embodiment, the one or more steps illustrated in FIG. 3 may be implemented through a controller, computer or other logic system and/or in a non-manual manner using feedback sensing devices as discussed in more detail below. The controller may be or include a wired controller connectable to the load transporting apparatus, a wireless controller configured to wirelessly communicate with the load transporting apparatus, and combinations thereof.

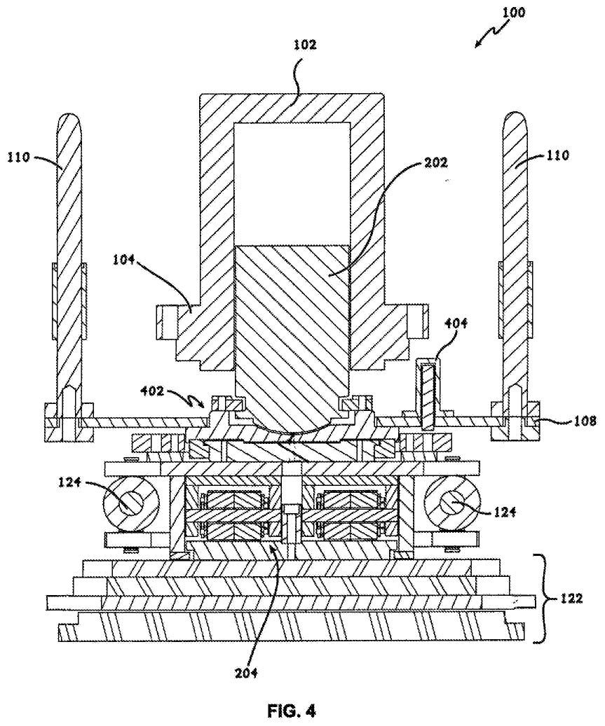

FIG. 4 illustrates a cross-sectional view of the walking assembly of FIG. 1. The lift motor 102 is shown to comprise a hydraulic cylinder with piston 202. The piston 202 may be configured to operatively couple a rotary interface 402, discussed in more detail below, which in turn is configured to operatively couple the translation assembly, discussed in more detail below, which in turn is operatively coupled to the foot 122.

FIG. 4 also illustrates a rotary interlock 404 configured to lock the ring gear 118 into a particular orientation during a walk. Although only one rotary interlock 404 is illustrated, the walking system 100 may comprise two or more interlocks 404. It is preferred that the interlock be configured to couple the origin frame 108 to the ring gear 118. Alternately, the interlock can couple the lifting frame 104 to the ring gear 118. The interlock 404 may be a motorized pin that is configured to engage one or more teeth on the ring gear 118, or one or more holes in the ring gear 118. The motorized pin may comprise a hydraulic cylinder or electric solenoid, or other similar structure. The interlock also may be operated manually.

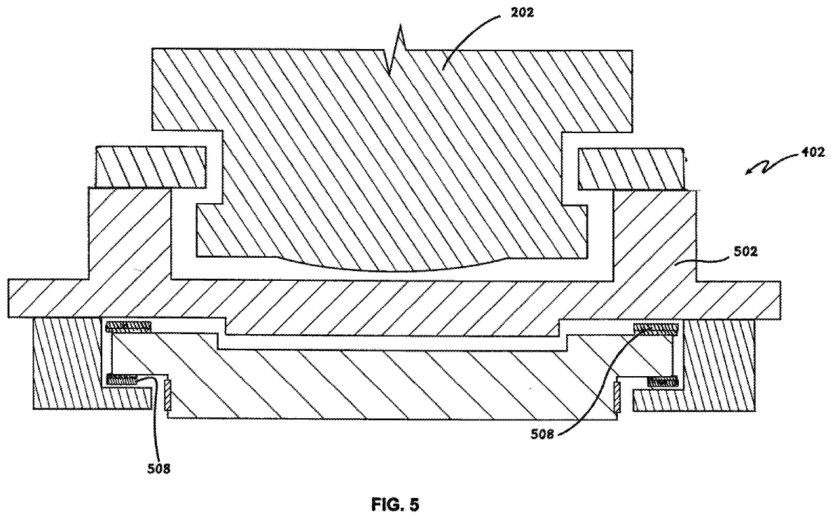

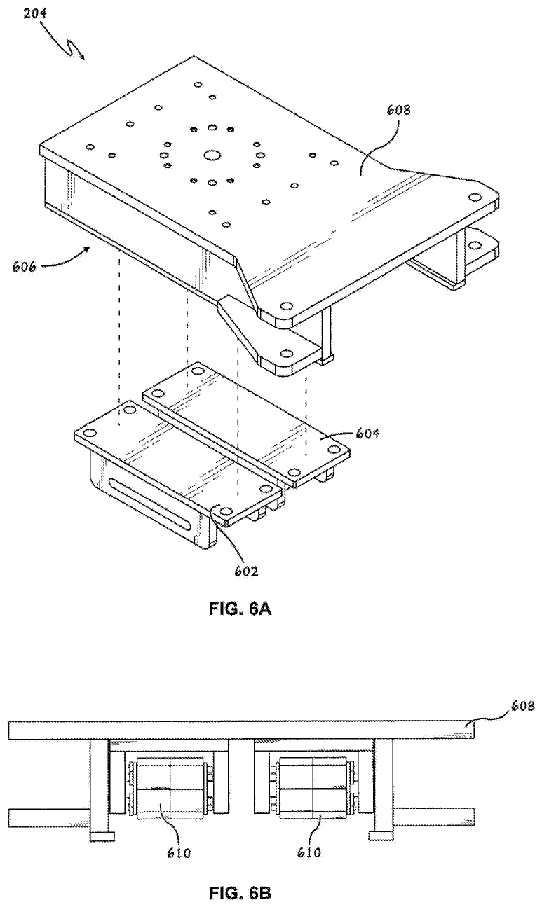

FIGS. 5 and 6A-B illustrate embodiments of a rotary interface 402 and a translation assembly 204. In FIG. 5, the rotary interface 402 may comprise several structures configured to allow unloaded rotation between, for example, the origin plate 108 and the foot 122 while securing the weight of components below the origin plate 108 (e.g., the rotary interface 402, the translation assembly 204 and foot 122) when the foot 122 is retracted from contact with the ground.

As illustrated in FIG. 5, the rotary interface 402 may comprise a piston 202 receiver 502 configured to securely engage with the origin frame 108 or load frame 104 and with piston 202. The receiver 502 comprises a piston bearing area 504 configured to support the forces encountered when lifting the load. In a preferred embodiment, the receiver 502 does not rotate relative to the load. The interface 402 also may comprise a rotation disc 506 configured to be lifted by the receiver 502 when the lift motor 102 is retracted and configured to rotate relative to the receiver 502 when the lift motor 102 is retracted. The rotation disc or coupler 506 is configured to be secured to an upper housing (See FIG. 6A) of the translation assembly 204. It will be appreciated that when the lift motor is retracted and the walking system 100 is not carrying the weight of the load, the rotation motor 112 may rotate the ring gear 118, which rotation causes the translation assembly 204 and therefore coupler 506 to rotate relative to the origin frame. As can be seen in FIG. 5, bearing surface 508 may be beneficially used. Also, the rotary interface 402 suspends weight of the components below the origin frame 118 when the foot is retracted. Once the translation assembly 204 is correctly oriented, the rotary interlock 404 may be engaged to lock the orientation of the translation assembly 204 to the origin frame 118 and/or load.

FIG. 6A illustrates an embodiment of a translation assembly 204 comprising two low friction devices 602, 604, such as rollers, and an upper housing 606. Each roller module 602, 604 is secured within the housing 606 to the upper surface 608. As illustrated in FIG. 6B, upper portions of rollers 610 may or may not carry load, but the lower portions of the rollers 610 contact a surface associated with the foot 122 and allow the foot 122 to be translated or displaced relative to the housing 606.

It will be appreciated that the ring gear 118 may be secured to the upper surface 608 of the housing 606. The housing 6060 may be connected to a portion of the rotary interface 402, such as coupler 506 to allow the ring gear 118 to be mounted thereon in a location around the rotary interlock. This arrangement provides for an axial datum of rotation.

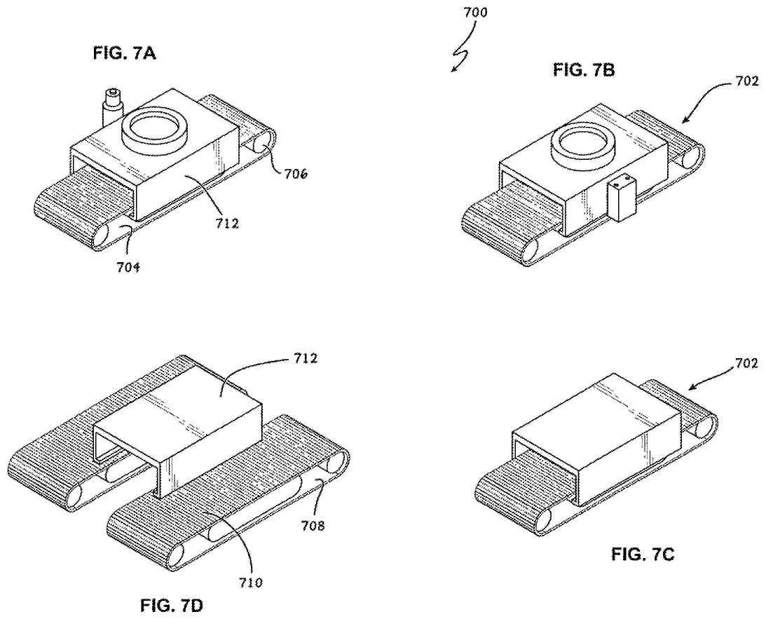

FIGS. 7A-7D illustrate another type of low friction device 700 that may be used with walking systems like those disclosed above. FIG. 7A illustrates a tracked rolling mechanism 702 comprising a metal or composite flexible track 704 disposed over a roller mechanism 706. While only two rollers 706 are visible in FIG. 7A, those of skill will appreciate that a plurality of rollers will be needed to carry the weight of the load during walking. FIG. 7D illustrates an embodiment comprising dual tracks 708 and 710. As described above, it is preferred that the housing 712 be secured to and carried by a rotary interface that allows the orientation of the track to be set by the rotary motor. It is contemplated that that the track can be configured to directly contact the ground, or to utilize a shoe, as described herein.

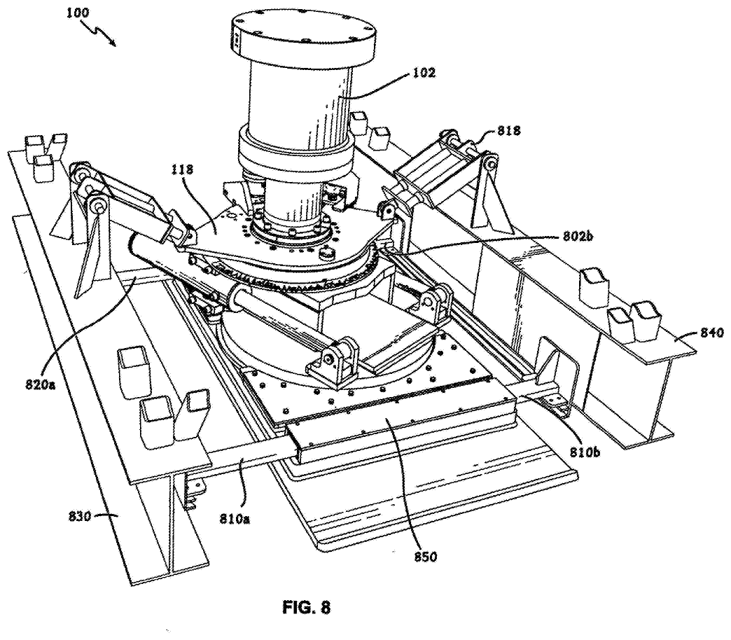

FIG. 8 is an illustration of a stabilizer frame assembly 800 configured for engaging a walking system, such as system 100. It will be appreciated that the stabilizer frame assembly may be added, such as by retrofit, to an existing load (e.g., drilling rig) or may fabricated as part of a walkable load.

The stabilizer frame assembly may have a first stabilizer bar 810 configured to connect to the load transporting apparatus 100. The first stabilizer bar 810 may have a first end 810a and a second end 810b. The first end 810a may be configured to connect to a first sidewall 830. The second end 810b may be configured to connect to a second sidewall 840.

The stabilizer frame apparatus may have a second stabilizer bar 820 configured to connect to the load transporting apparatus 100. The second stabilizer bar 820 may have a first end 820a and a second end 820b. The first end 820a may be configured to connect to the first sidewall 830. The second end 820b may be configured to connect to the second sidewall 820.

The first and/or second sidewalls may be separate from a rig structure and configured to integrate into the rig structure in a non-limiting embodiment. Alternatively, the first 820 and/or second sidewalls 840 may be part of the rig structure, and the first stabilizer bar 810 and the second stabilizer bar 820 may be configured to connect thereto. In a non-limiting embodiment, the stabilizer frame apparatus may include the first sidewall 830 and/or the second sidewall 840.

In a non-limiting embodiment, the stabilizer frame apparatus may include at least one, and preferably two, origin stabilizers 818 configured to connect to at least one of the first sidewall 830 and/or the second sidewall 840. In a non-limiting embodiment, the origin stabilizer(s) 818 may pivot from a fixed location when connected to the first sidewall 830 and/or the second sidewall 840.

In another non-limiting embodiment, the first stabilizer bar 810 and/or the second stabilizer bar 820 may have an optional stabilizer frame apparatus coupler 850 for easier coupling of the stabilizer frame apparatus to the load transporting apparatus 100. When the stabilizer frame apparatus coupler 1550 is not used, the first stabilizer bar 81 and/or the second stabilizer bar 820 may engage or connect or attach to the load transporting apparatus 100 such as by welding, riveting bolting, or another form of coupling the stabilizer frame apparatus to the load transporting apparatus 100.

In yet another non-limiting embodiment, at least one additional crossbar (not shown) may be configured to connect to the first sidewall 1530 and/or the second sidewall 840 for additional stability of the load and/or load transporting apparatus.

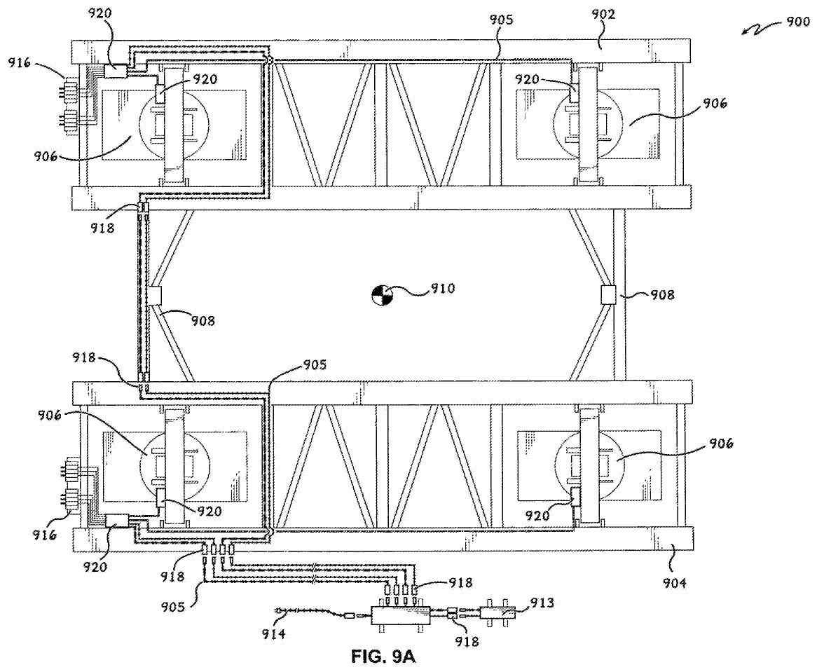

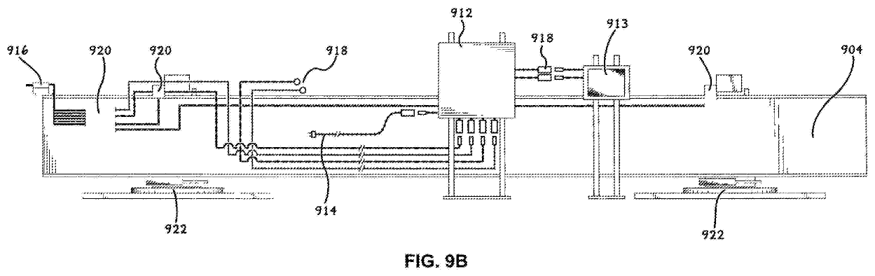

FIGS. 9A and 9B illustrate a pony structure 900 useful in retrofitting a non-walking load, and in fabricating a new walking load. The pony structure 900 may comprise two substructures 902 and 904, each substructure configured to house within the substructure at least one walking system 906. Any of the walking systems disclosed herein and, in the material, incorporated by reference are suitable for embodiments of the invention. As illustrated, each substructure 902, 904 may be separated and supported by a truss system, such as the disclosed K-truss or K-bar system 908. The K-truss system 908 preferably is removable to facilitate walking over obstacles. As has been disclosed, it is preferred that the walking systems be oriented about the center of mass 910 of the load.

FIGS. 9A and 9B also illustrate a walking system control system 901 comprising a master control unit 912 and associated human-machine interface 913 and power cable 914. In this embodiment, the master control unit 912 is permanently affixed to one of the substructures 902, 904. Control cables 905, which may be armored or not, run along the substructures to each walking system 906 and interface with the associated hydraulic controls 916 for each substructure 902, 904, and with each walking system 906. As illustrated, the control system comprises multiple connection points 918, such as Amphenol connections, which are relatively expensive and sensitive to abuse. A downside to a permanently installed control system is that it may become damaged during normal use of the load, when the load transporting system is not in use. Another downside is that each load requires its own master control unit. For example, on a drilling rig, weather, pressure washing, falling, or dropped equipment or tools routinely damage the control cables 905, junction boxes 920 and connections 918. FIG. 9B is a side view of a substructure 902, 902 and show a foot of the two walking systems associated with the substructure.

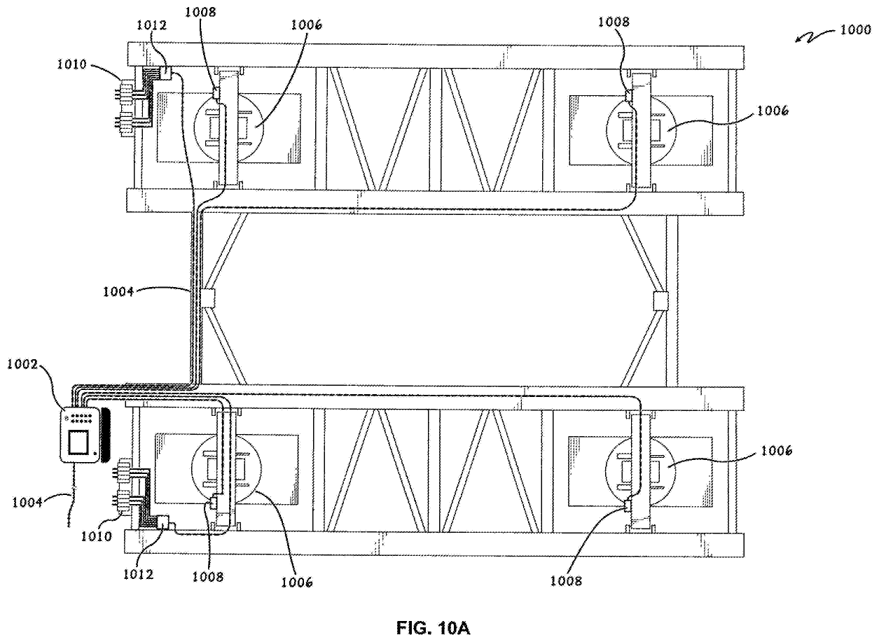

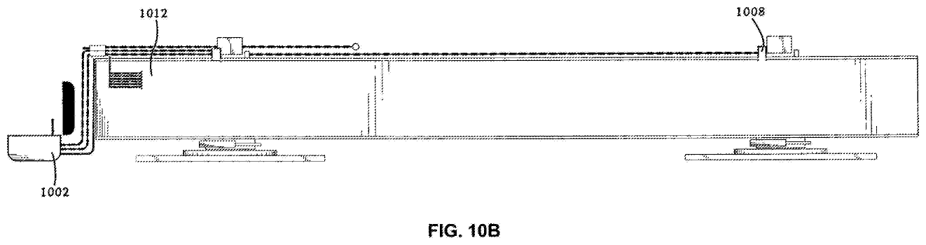

FIGS. 10A and 10B illustrate an alternate control system 1000 for pony structure 900 comprising a portable or removable master control unit 1002 and associated power cable 1004. In this embodiment, each walking system 1006 is wired to one or more permanent junction boxes 1008 located adjacent the walking system 1006 and shielded, such as by the substructure, from falling or dropped items. The hydraulic valves 1010 also are wired to permanent junction box 1012. These junction boxes 1008, 1012 may be wired with armored cable or wiring conduit to prevent to reduce damage to the control wiring.

The portable control system 1002 comprises cabling 1014 that connects the portable master control unit 1002 to the junction boxes 1008, 1012, and which can be removed when the load has been moved to the desired location. It will be appreciated that most loads are moved infrequently and are operated at most locations for longer periods of time than are involved in the walking the load to a new location. Thus, while the walking systems 1006 may, but are not required to, remain with the load when not in use, there is usually no need for the walking system master control unit 1000 to remain with the load. In this embodiment, the control system 1000 is operatively coupled to the load (i.e., to the hydraulic valves and walking systems) when the load needs to be moved and is uncoupled and removed from the load when the move is finished. Among the other advantages, the portable control unit 1002 minimizes the risk of damage to the control system when it is not being used. Additionally, as discussed below, the portable control system 1002 may be used with a plurality of loads. In other words, a dedicated control system is no longer required for each walking load. In use the portable master control unit 1000 may be temporarily hung from the substructure 1000.

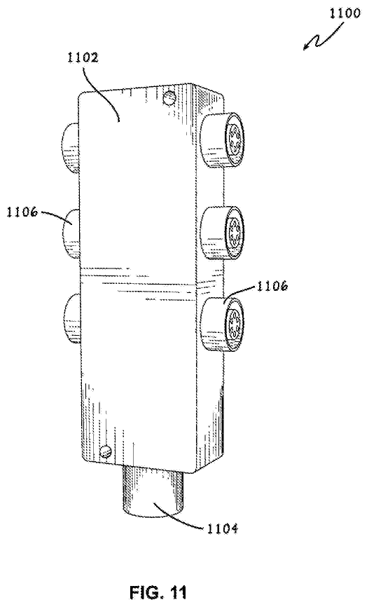

FIG. 11 illustrates a junction box 1100 suitable for use with the portable master control unit inventions described herein. The junction box 1100 comprises a rigid body 1102 fabricated from metal or plastic or composite. An input port 1104 is configured to receive an electrical or control signal and power cable (not shown) from the portable master control unit (e.g., 1002) and to distribute (including bi-directional) the power or signals to the appropriate output port 1106. The inside of the junction box 1100 is preferably filled with epoxy or other potting material to insulate and isolate the internal connections from the environment and damage. As described above, the output ports 1106 may be permanently wired to the appropriate component on the walking system, such as a pressure transducer, or displacement transducer. Alternately, one or all the output ports may have removable cables that come and go with the portable master control unit. The junction box 1100 illustrated in FIG. 11 is a six-port box.

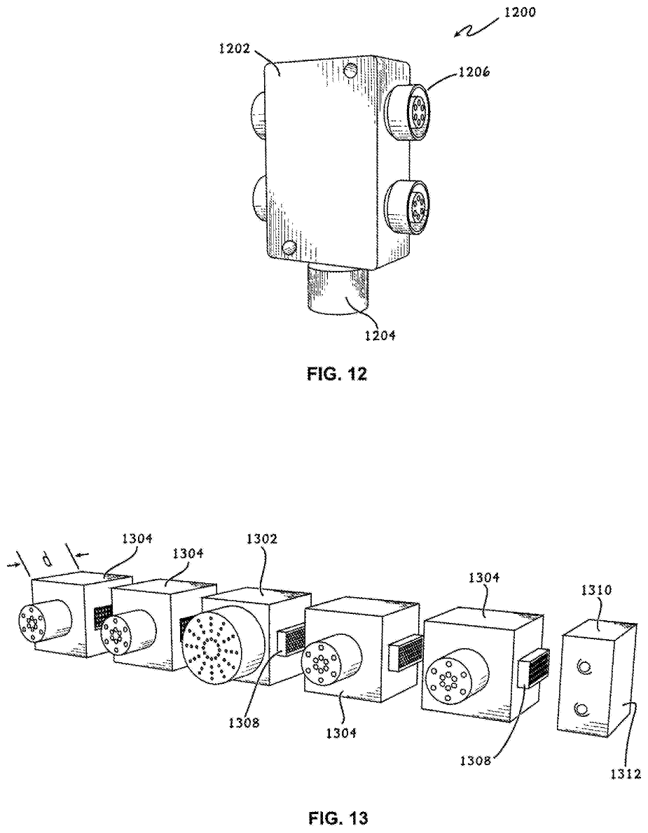

FIG. 12 illustrates a 4-port box 1200 have a body 1202, a single input 1204 and 4 output ports 1206. The junction box 1200 may be fabricated similarly to the junction box 1100 describe above. Suitable junction boxes are available from Turck, Inc. of Minneapolis, Minn.

FIG. 13 illustrates a modular junction box system 1300 suitable for use with the present inventions comprising an inlet module 1302 and a plurality of output modules 1304. Each module 1302, 1304 comprises on one side a recessed or female connector (not shown) and on the opposite side a projected or male connector 1408. The modules may be stacked together as need to form a modular junction box for a walking system, or a hydraulic control system or other systems. Each module 1302, 1304 may be hardened, such as by fabricating from metal or other rigid material. Further, it is preferred that the internal connections within each module be potted in epoxy or other similar material to provide environmental and physical damage protection. A termination module 1310 may be used at each end to seal off the modular junction box 1300. It is contemplated that the size of the modules 1302, 1304, 1310 is optimized to use the natural shielding of the load's components to prevent or reduce impact damage to the modular junction box 1300. For example, and not limitation, a depth “d” of the modules may be configured such that if the modular junction box is secured to the web of an I-beam, the modular junction box is shielded or protected by the flange portion.

In a preferred embodiment of a portable master control system for a walking system or load transporting apparatus, it is contemplated that the signal cables and junction boxes be configured for bi-directional analog signals. In other words, in this embodiment, it is preferred that all digital processing of signals be performed in the portable master control unit and the control signals be converted to analog for transmission to the walking system(s). It will be appreciated that analog transmission simplifies the junction boxes and connections and cables and minimizes the damage that may be done to this equipment while on the load. While analog transmission to and from the portable master control unit is presently preferred, transmission of digital signals to and from the portable master control unit is also contemplated with corresponding digital junction boxes, as desired.

Because a portable master control unit may be used with more than one load transporting apparatus (e.g., multiple rigs owned by single operator), it may be beneficial to identify the specific load being controlled by the portable master control unit. Because different loads may use different types of transducer, such as LVDTs or string pots, and control elements, each load may have its own calibration factors and control responses. For purely analog systems, a load ID may be inputted into the portable master control unit, which my then access stored load specific control information or download load specific control information from an Internet location. Alternately, a bar code, QR code or RFID may be physical associated with the load and read by a suitable scanner operatively coupled, such as wirelessly, to the portable master control unit. Still further, one or more of the junction boxes described above, such as the modular junction boxes of FIG. 13 may comprise a termination module 1312 that include a readable identification code such as a resistance code. For digital or combined analog-digital systems, the termination module may comprise a readable chip or other circuit that provides load identification and may also provide load specific control information. In the latter embodiment, load specific control information may be communicated from the load to the portable master control unit, rather than the portable master control unit accessing stored information or downloading control information.

The master control unit preferably comprises a plurality of bi-directional connection points for establishing communication with the load transporting apparatus. A preferred embodiment comprises 6 such connections, but any number of connection between 1 and 10 should be sufficient. Because different walking loads may be configured (i.e., wired) differently, the master control unit is preferably programmable to activate the current number of connections for a particular walking load. For example, the load transporting apparatus of FIG. 10A needs 6 active connections, whereas other load transporting apparatuses may require 4, 2 or 1 active connections. It is contemplated that the operator may select the active connections through the HMI interface, or alternately, the load ID, such as QR code or readable chip, may specify the number of active connections needed.

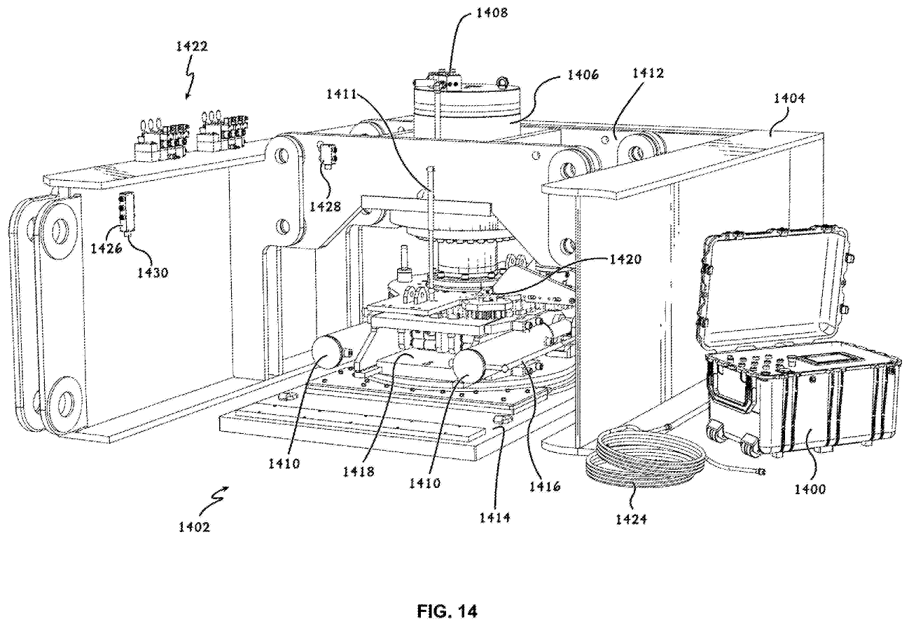

FIG. 14 illustrates a portable master control unit 1400 and a walking system 1402 operatively coupled to a frame portion 1404 of load, or alternately, to a walking system substructure for a load. It will be understood that walking system 1402 may one of several walking systems deployed on the load, such as represented in FIGS. 10A-10B. The walking system 1402 illustrated comprises a lift cylinder 1406 with an associated pressure transducer 1408, and two translation cylinders 1410, which may or may not have associated pressure transducers. In this preferred embodiment a linear variable differential transformer (transducer) or LVDT 1411 is operatively coupled between a portion of the frame, such as cross head 1412 and the walking system 1402 to transduce axial movement, rate of movement, and/or position of the shoe 1414. A second LVDT 1416 may be operatively coupled to the transporting subsystem 1418 to transduce lateral movement, rate of movement, and/or position of the shoe 1414. Either or both of the LVDTs also may comprise an accelerometer to transduce the rate of change of displacement. It is preferred, but not required, that the LVDTs be hardened or armored to prevent or reduce physical. The walking system 1402 also comprises a rotary encoder 1402 operatively coupled to the ring gear (see, e.g., ring gear 118 in FIG. 1) configured to transduce the absolute rotary position of the shoe 1414.

Also illustrated in FIG. 14 are hydraulic controls 1422 plumbed to allow control of the hydraulic components of the walking system 1402, such as the lift cylinder 1406, the translation cylinders 1410 and rotary motor (see, e.g., rotary motor 112 in FIG. 1). The controls 1422 provide both manual and electronic control. Should electronic control from the portable master control unit 1400 fail for any reason, manual control of the walking system 1402 is possible.

Turning now to the portable master control unit 1400, FIG. 14 illustrates the control unit housed in ruggedized plastic case, such as a Pelican case, which may be wheeled to the load's location for use. Two cables 1424 are shown for operatively coupling the master control unit 1400 to junction boxes 1426 and 1428 securely affixed to the frame 1404 or 1412, as shown. It is preferred that the junction boxes comprise the junction boxes described with respect to FIGS. 11-13. One end of one of the cables 1424 is connected to the appropriate connector on the master unit 1400 and to the appropriate connector 1430 of junction box 1426. While not illustrated, it will be appreciated that the junction box 1426 is operatively coupled to the hydraulic controls 1422 to allow the master unit 1400 to control the walking system 1402. The second cable 1424 is connected between the master control unit 1400 and the junction box 1428 to provide transmission of signals, such as pressure and LVDT signal to and from the walking system 1402 and control unit 1400.

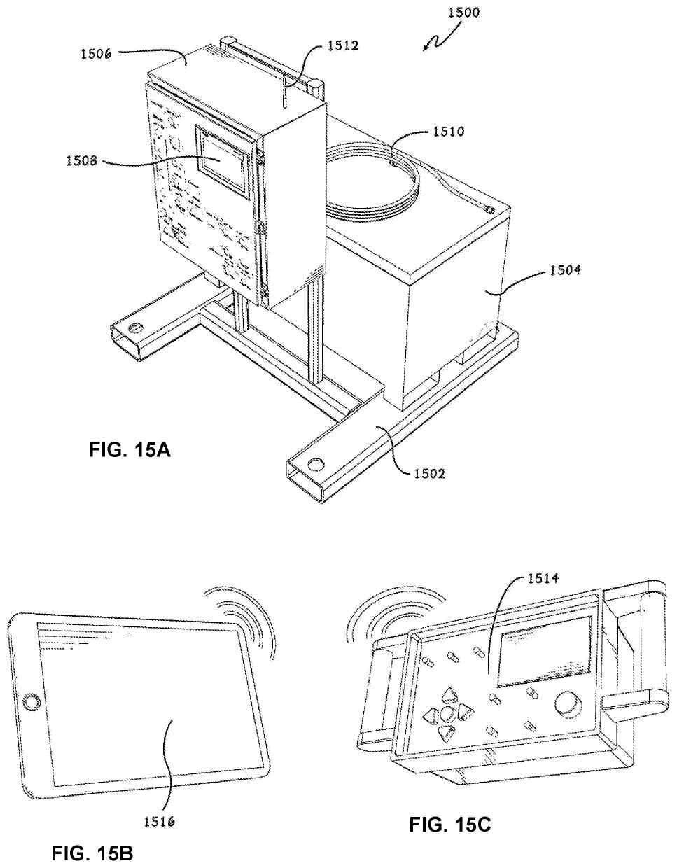

FIG. 15 illustrates a preferred form of portable master control unit system 1500 for use with the walking systems disclosed herein. The system 1500 comprises a frame 1502, a storage chest 1504 and a control unit 1506. It is preferred that the system 1500 be moveable with a forklift, gin pole truck or similar device. Alternately, the system may have wheels (not shown) and may be pushed to location. Other embodiments may comprise a prime mover such as an electric motor to provide locomotion for the system 1500. As previously described, the control unit may comprise a human-machine interface 1508, such as a touch screen and preferably a weatherized touch screen, and various control and operation buttons and switches. In addition, the control unit 1506 comprises the necessary number of connection ports (not shown), including for primary power for the control unit, and for connection to the junction boxes on the load. It will be appreciated that depending on the number of walking systems deployed on the load and the number of junction boxes used, control unit 1506 to load connection may comprise 1 connection, 2 connections, 4 connections, 6 connections or more. The storage chests 1504 may be used to store the cable(s) 1510, wireless interface, and other equipment when not in use.

It will be appreciated that just like with non-portable walking system control units, the portable master control units described herein may wirelessly interface 1512 with a personal control unit 1514 or belly pack providing a single human operator control over the walking systems through the master control unit 1506 during a walking operation. Tablets 1516 and other smart device also may interface with the master control unit 1506, such as to monitor walking download or upload files and reports and the like. The master control unit 1506 also may connect to the Internet through conventional means such as cellular or satellite technologies.

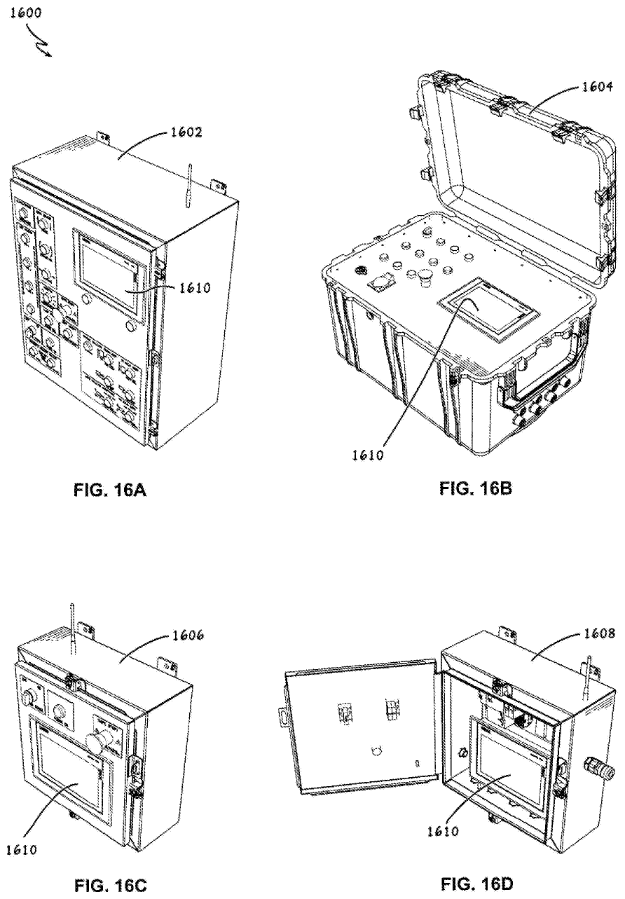

FIGS. 16A-16D illustrate various possible embodiments of portable master control units 1602, 1604, 1606 and 1608. As illustrated, it is preferred, but not required, that a portable master control unit comprise a touch screen 1610. Alternately, a screen and keyboard/mouse/pointer system may be used. All of these embodiments are weatherized and ruggedized, but are yet portable.

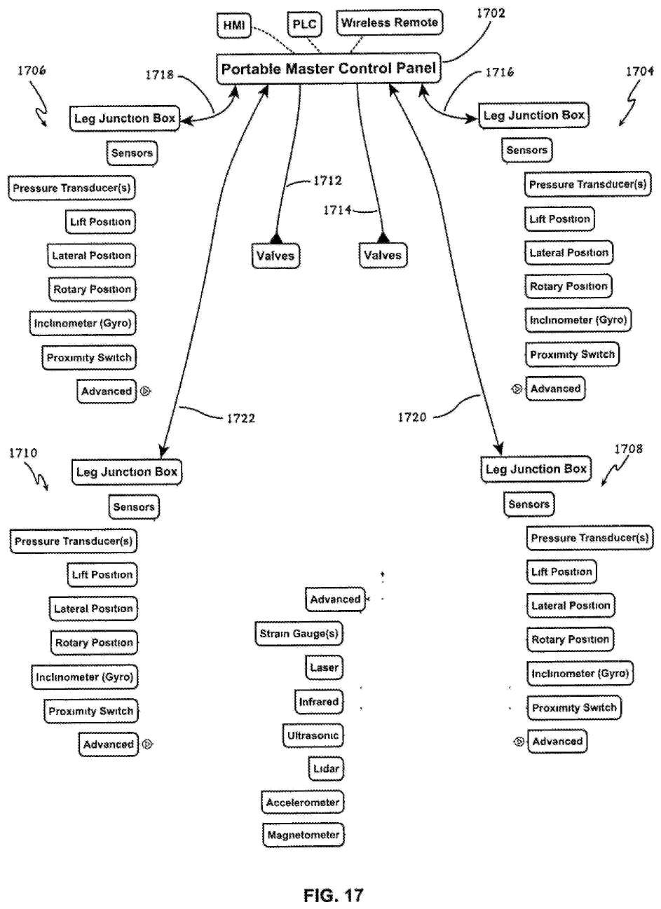

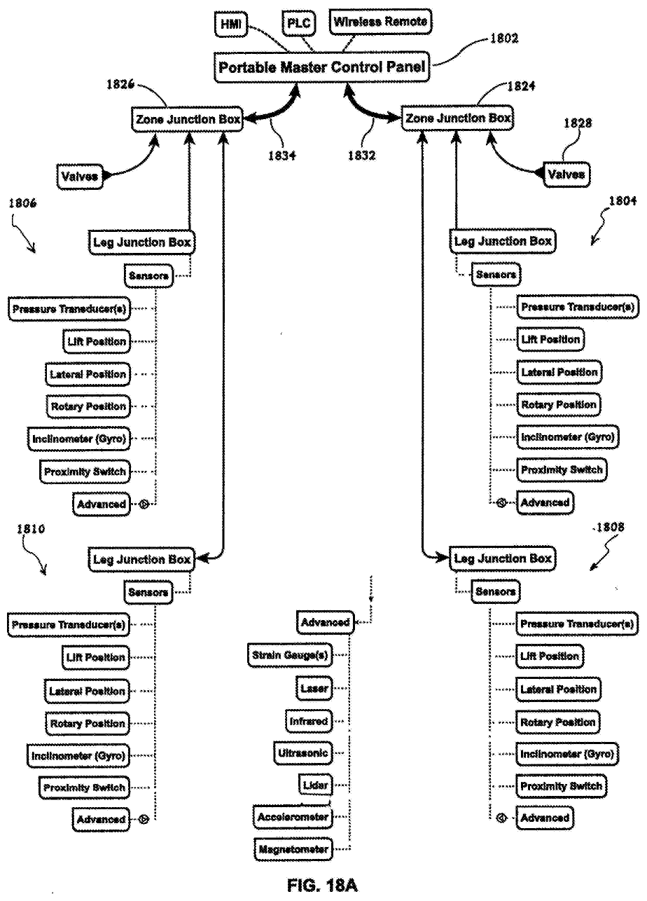

FIG. 17 illustrates control links (i.e., cables) from a portable master control unit 1702 to 4 walking systems 1704, 1706, 1708, 1710, deployed on a load, such as illustrated in FIGS. 10A-10B. Each side or leg of the substructure receives a hydraulic control cable 1712, 1714. Each walking system receives its own control cable 1716, 1718, 1720, 1722, configured to interface through the junction box with the various sensors and transducer deployed on the walking system.

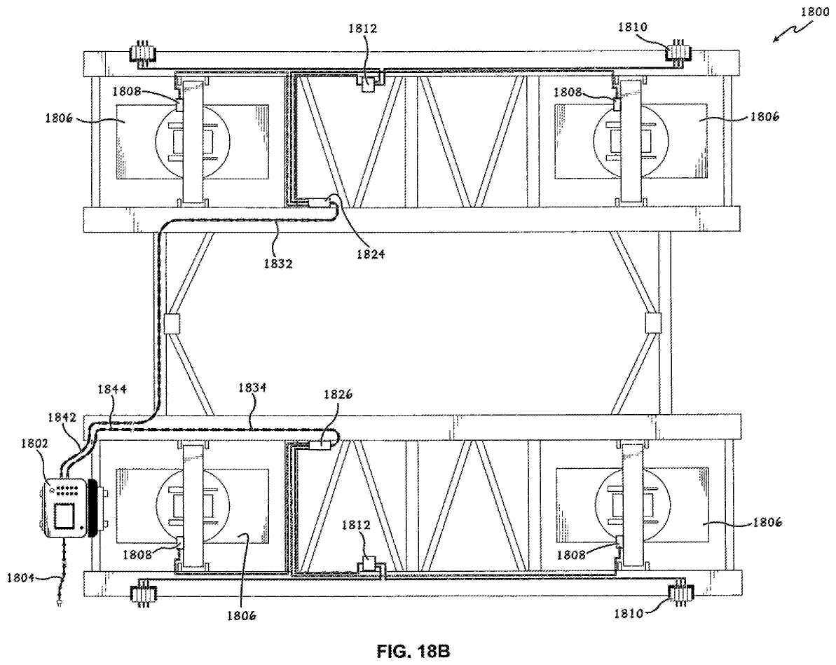

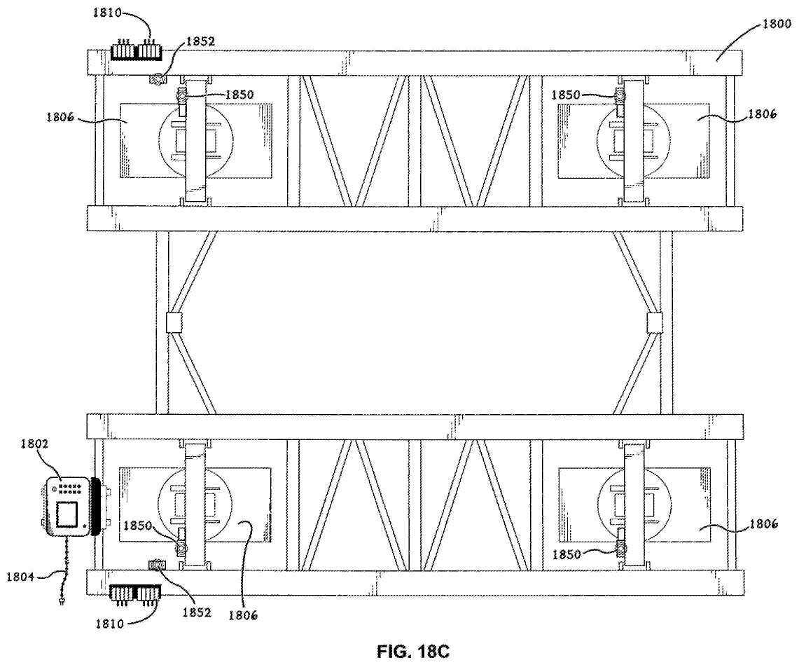

FIG. 18A illustrates control links (i.e., cables) from a portable master control unit 1802 to 4 walking systems 1804, 1806, 1808, 1810, deployed on a load, such as illustrated in FIGS. 10A-10B. Each side or leg of the substructure comprises a zone junction box 1824, 1826, which then distributes control links to each walking system and hydraulic control valve 1828, 1830. This arrangement requires only two cables 1832, 1834 from the portable master control unit 1802 to the load (i.e, 2 active connections) The control links between the zone junction boxes 1824, 1826 may be removable along with the portable master control unit link (1832, 1834) or may be permanently installed on the load.

The position sensors identified in FIGS. 17 and 18A may comprise LVDT, Lidar, Infrared, or Laser, as shown. An inclinometer may be used to determine whether the load is level or is tilting. Strain gauges may be coupled to various portions of the walking system to determine an amount of strain or stress on the associated component. If the strain exceeds a predetermined value, the control unit may shut down the lift or walk or otherwise take corrective action.

FIG. 18B illustrate a control system for load transporting structure 1800 comprising a portable master control panel 1802 and associated power cable 1804. The control link layout shown in FIG. 18A is applicable to this embodiment. In this embodiment, each walking system 1806 is wired to one or more permanent junction boxes 1808 located adjacent the walking system 1806 and shielded, such as by the substructure, from falling or dropped items. The hydraulic valves 1810 also are wired to permanent junction box 1812. These junction boxes 1808, 1812 may be wired with armored cable or wiring conduit to prevent to reduce damage to the control wiring. These junction boxes 1808 and 1810 are permanently wired to zone junction boxes 1824 and 1826 as illustrated. It will be note that in this embodiment, the portable master control unit 1802 needs only two removable cables 1842 and 1844 wired from the control unit 1802 to the zone junction boxes 1824, 1826.

The control link layout shown in FIG. 18A is applicable to this embodiment. In this embodiment, each walking system 1806 is wired to one or more permanent junction boxes 1808 located adjacent the walking system 1806 and shielded, such as by the substructure, from falling or dropped items. The hydraulic valves 1810 also are wired to permanent junction box 1812. These junction boxes 1808, 1812 may be wired with armored cable or wiring conduit to prevent to reduce damage to the control wiring. These junction boxes 1808 and 1810 are permanently wired to zone junction boxes 1824 and 1826 as illustrated. It will be note that in this embodiment, the portable master control unit 1802 needs only two removable cables 1842 and 1844 wired from the control unit 1802 to the zone junction boxes 1824, 1826.

FIG. 18C illustrate a control system for load transporting structure 1800 comprising a portable master control unit 1802 and associated power cable 1804. This master control unit 1802 is different than those previously described in that it communicates wirelessly with the walking systems 1806. As illustrated, each walking system 1806 comprises a wireless transceiver junction 1850, and the substructure comprises a wireless transceiver junction 1852 for each hydraulic valve control. Although not illustrated in FIG. 18C, it is understood that each wireless junction 1850 is wired to the appropriate actuators, components and transducers, such as illustrated in FIGS. 17 and 18A, and that each wireless junction 1852 is wired to the appropriate hydraulic control valve e1810. It is preferred that the wireless junction boxes 1850, 1852 be weatherproofed and ruggedized, and placed in areas shielded from impact and other damage without comprising wireless connectivity.

An alternate wireless master control system comprises wireless transceivers associated with the junction boxes and configured to communicate to a website or software application on a smart phone or tablet via cellular communication protocols, or via a temporary wireless network. For example, if the junction boxes comprise a wireless transceiver, when it is desired to move the load, an operator may establish a temporary wireless network around the load and communicate sensor and control signals to and from the load transporting apparatus from a smart phone or tablet. Alternately, using cellular communication, communication of sensor and control signals to and from the load transporting apparatus may also involve a website to display information about the move and/or control the move.

Wireless digital protocols such as WPAN, WSAN (WSN) and WLAN may be suitable for communication to and from the master control unit 1802. A meshnet topology is beneficial with a plurality of walking systems. Because latency may present control issues, hybrid transceivers are contemplated in which sensor data is transmitted in analog form from the wireless junction boxes and control instructions received from the control unit in digital format.

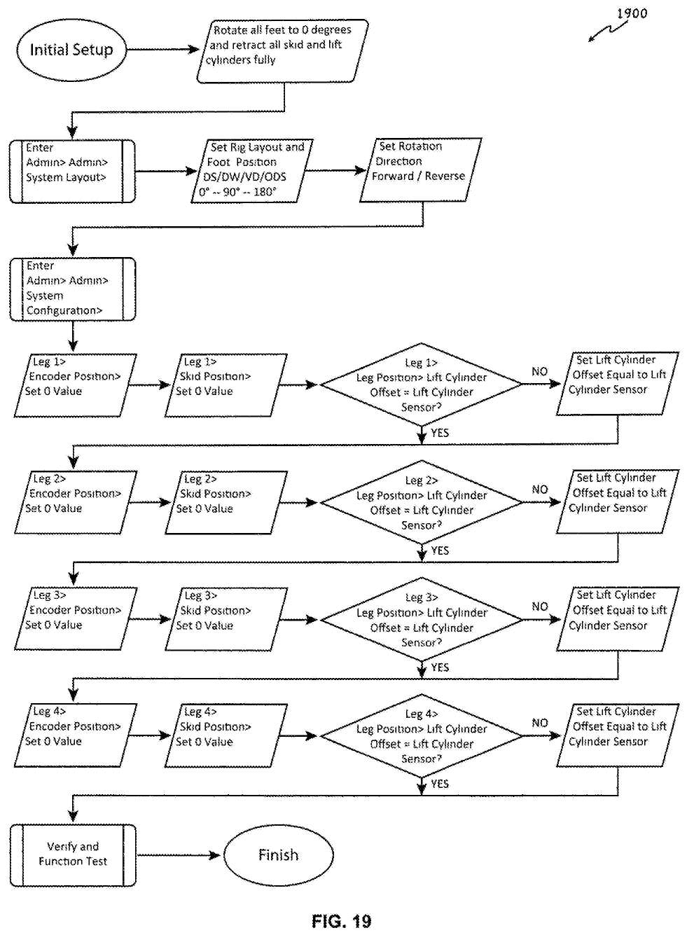

Because each load transporting apparatus may be unique in number of walking in systems deployed and in the control and transducing components utilized, a start up or initialization routine is useful each time the portable master control unit operatively engages the load. FIG. 19 illustrates a flow chart or sequence routine 1900 for one type of initialization routine suitable for use with the portable master control units of the present disclosure. As can be seen, the routine contemplates initially fully retracting all lift and translation cylinders and rotating all feet to 0 degrees. The forward and reverse foot directions may be set for each walking system and the foot rotation encoder values set to 0. Next, the foot position based on the fully retracted translation cylinders may be set to 0. Next, the lift cylinder offset for each walking system may be set or modified as needed. Once this initialization is completed, the operation of the load transporting apparatus may be tested and verified.

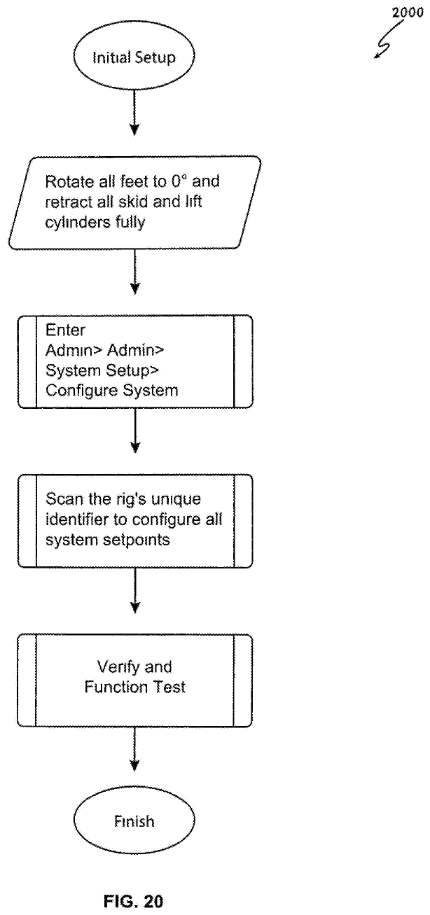

FIG. 20 illustrates another flow chart or sequence routine 2000 suitable for use with the portable master control units of the present disclosure. As can be seen, the routine contemplates initially fully retracting all lift and translation cylinders and rotating all feet to 0 degrees. Unlike the routine in FIG. 19, this routine determines the load's unique identification, such as discussed above. Based on the ID, the portable master control unit can access the necessary initialization file having the particular initialization parameters for the components on the load, or the control can download the file. Based on initialization file for the load, the operation of the load transporting apparatus may be tested and verified.

When a portable or non-permanent master control unit is desired to be used with an existing load transporting apparatus, an initial setup routine may be implemented from a GUI menu on a human-machine interface, which preferably will have predetermined options to choose from. Setup queries may include how many communication junction boxes are used, type of signals from the junction boxes, type of sensors, valves, or other devices in which in/outputs may be configured and stored in the master control unit. Of course, if predetermined junction boxes are not available from dropdown list, custom setup of junction boxes from the interface can be selected. All devices (e.g., sensors) connected to the junction boxes can be configured from the interface to allow the MCU to process data correctly. Alternately, as discussed previously, a unique junction box identifier can be implemented at the junction box in which the program can interpret and retrieved the predetermined load transporting apparatus setup (e.g., junction box setup). As discussed, this can be a RFID chip, Barcode, QR code, chip or other identifying circuit.

A setup or initial configuration routine for a portable master control unit may comprise selecting the orientation of walking system feet as referenced to their location and orientation on the structure or load to establish a direction for each walking system between 0-180 degrees. The MCU preferably has the ability to flip the rotation 0-180 degrees to be on the opposite side if so desired. The sensors on each walking system that transmit data to the master control unit may be set up in the operational control of the master control unit, such as in the software. For example, scaling and/or offset adjustments for each sensor are preferably built into to the software or stored in memory of the master control unit. These values may be adjusted during set up. For example, systems utilizing 4-20 mA signal sensor signals may be adjusted during operation. Other sensor types such a digital may require hardware and/or software to set the appropriate scaling or offsets.

Walking system alarms or limits for that specific load transporting apparatus may be set. For example, rate of lift limits may be set, foot translation limits relative to foot orientation may be set, or out of level limits may be set.

The walking feet may be oriented to the 0-degree direction (e.g., longitudinal direction relative to walking system substructure) and the lift cylinders and the translation cylinders fully retracted. The zero set points the translation cylinders and foot orientation may be reset as desired. If the lift cylinder LVDT shows an offset, the offset value may be inputted into the master control unit as a correction.

Each lift cylinder may have common or independent predetermined speeds for extension and retraction while under load, and while unloaded. For example, a lift speed (which will always be under load) may have a cylinder extension speed set point that is relatively slow. The cylinder retraction speed may be set at the same speed as the lift speed or at a faster or slower speed. An unloaded retraction speed (i.e. the speed of cylinder retraction after the load is bearing on the surface (e.g., ground) may be, and preferably is, much faster than the lift or loaded retraction speeds, such as the maximum speed available.

The lift cylinders may be extended at a predetermined rate or at a natural uncontrolled rate to raise the load until it is just lifted from the supporting surface, e.g., ground. The master control unit may be configured to read and store the lift cylinder pressure value and the displacement value (such as from the LVDT) for each walking system at this lifted condition. It is preferred that the master control unit also be configured to store a “preload” lift pressure value for each walking system and “preload” displacement” value that are between about 7% and 12% more than the lift pressure cylinder value and displacement value previously recorded. For example, the operator may set the preload value (e.g., 750 psig), or may set the percentage increase for the preload (e.g., 10%). It will be understood that the preload pressure value may be used by the master control unit to determine whether each foot is bearing the weight of the load. The preload displacement value may be used in conjunction with the preload pressure value to determine whether the surface is collapsing

To move the load in a particular direction, the operator may select the walking direction for an individual step or the walking direction for a plurality of steps. If master control unit determines that all feet are bearing the weight of the load, then the MCU may lower the load (retract the lift cylinder) at the “retract under load speed” (if set) while monitoring the lift cylinder pressures transmitted to the MCU. When the lift cylinder pressure falls below the preload pressure, the MCU may continue retracting the lift cylinders at the same or different speed, such as a maximum speed, until the lift cylinder LVDT (or other displacement transducer) reaches a predetermined height relative to the ground or to the lift structure.

Once the feet are unloaded (either at the predetermined height or during unloaded retraction) the translation cylinders may be moved (extended/retracted) to a home position, which preferably is half the distance of the cylinders' travel. Alternately, home position may be the fully retracted position. Once in the home position, or while the translation cylinders are seeking the home position, the MCU may send a control signal to the rotation motor to orient the feet in the direction of travel.

Once the lift cylinders are at the predetermined height, the translation cylinders are at the “home” location, and the feet are oriented in the desired direction, the MCU may extend the lift cylinders at whatever speed is desired, such as maximum speed or natural speed, until each lift cylinder has attained the preload pressure.

Once the preload cylinder pressures are reached, the lift cylinders continue to extend at a predetermined rate of speed, such as by controlling the electrical current to the lift cylinder hydraulic control valve and maintaining the displacement of each lift cylinder within about ½″ of each other to ensure an even or level lift of the load. The MCU will control the lift of the load until the load is raised a predetermined distance above the surface (i.e., the walk height).

Once walk height has been reached, the MCU will extend the translation cylinders to push the load (e.g., extend the translation cylinders), such as by controlling the electrical current applied to the translation cylinder hydraulic control valves so that the cylinders on the walking systems move together within about ½″ from one another.

Once the step (i.e., translation of the load) has completed, the MCU energizes the lift cylinders to lower the load at the controlled rate of speed until the MCU detects that a pressure less than the preload pressure on all walking systems. When the lift cylinder pressure, preferably, but not necessarily, on all walking systems falls below the preload pressure, each foot may be retracted at, for example, its maximum rate of speed it reaches the reset height (typically about 4-5 inches above the surface). During post pre-load retraction or after reaching the reset height, the translation cylinders may be reset to the home position.

Having described a single step sequence in the context of the present inventions, it will now be appreciated that the MCU may be configured to string together multiple single steps to accomplish movement of the load in a seamless and controlled manner. In a preferred embodiment, a direction and distance or coordinate, such as GPS coordinate, is entered into the MCU, and the walking sequence activated, such as by depressing a button, GUI button or lever. The automatic walking sequence or autowalk may comprise the following routine.

The MCU determines whether all feet are oriented in the same direction. If not, the MCU orients the feet to the home (longitudinal direction), and then orients the feet in the desired direction of travel. The reminder of this description will assume the direction of travel is forward or reverse in the longitudinal direction. It will be appreciated that some load transporting apparatuses will have step stroke lengths that vary by orientation. Other apparatuses, such as those having step windows and outriggers described herein, may not be step stroke limited.

The MCU lowers the feet until the preload pressure has been realized for each lift cylinder. Each foot can lower at its own rate of speed, as described above. Once preload pressure is realized for a given cylinder, the lifting of that cylinder stops.

Once all lift cylinders have reached preload pressure and have stopped, the MCU energizes the lift cylinders to lift the load at the same predetermined rate of speed. If one leg lift cylinder falls behind or gains ahead the others (such as based on LVDT displacement), the MCU may slow down or speed up individual lift cylinders so that all are lifting the load within ½ inch differential among one another ensuring an even lift. It is also contemplated that one or more inclinometers may be incorporated into the load for use by the MCU in controlling the levelness of the lift.

Once the predetermined lift height has been reached, the translation or step is implemented by extending or retracting the translation cylinders from the home position. It is preferred that all feet translate within a ½ inch differential. For any deviation, the MCU may speed up or slow down an individual walking system. Once the maximum step or translation stroke has been achieved for that specific direction, the lift cylinders may be retracted at a controlled or predetermined speed. The MCU monitors whether any lift cylinder exceeds the preferred about ½ inch differential. Once a lift cylinder pressure falls below the preload pressure indicating that load is bearing on the surface, the lift cylinder may move at its own rate of speed to the predetermined reset height (which preferably can be dynamically changed with the HMI).

After reaching the reset height, or during the post-preload retraction, the translation cylinders are reset for the next step. The translation cylinders may move at their own rate of speed or a predetermine rate and stop when they get to home position or to the beginning of step. The MCU determines that the direction angle of each foot is still within tolerance (such as ±1 degree) and, if needed, a direction correction may be implemented. The step sequence is restarted by the MCU to continue the autowalk sequence for a predetermined number of steps, predetermined distance or to a predetermined coordinate.

During any step, whether autowalk or manual, if any one lift cylinder gets more than about ½ inch out of sync from the other lift cylinders (i.e., differential), the MCU will automatically stop the lift. If the direction angle deviates by more than the preset error (e.g., ±1 degree) the MCU will stop the step or will implement a direction correction once the feet are in the reset position. If a lift cylinder fails to attain the preload pressure when the other lift cylinders have, the MCU will stop the walk and the lift cylinder will continue to extend until preload has been achieved. If the stroke limit of the lift cylinder is reached, it is possible that the foot will have to be shimmed above the surface.

The MCU may also be configured to facilitate an automatic rotation of the load. In a rotate sequence, two feet will be at one angle and the other two will be at the other angle. Feet that are diagonal to each will have the same orientation but different stroke direction. In other words, the feet will be oriented in a circular pattern, and the autowalk or manual walk sequence may be implemented.

If a system error is detected, the MCU may automatically or the operator manually may place the system into an override condition. Once placed into system override, the operator may control each walking system individually or commonly, thereby overriding any programmed sequences.

It will know be appreciated having the benefit of this disclosure that multiple synergies may be achieved by utilizing a portable master control unit with a load transporting apparatus comprising a plurality of walking systems. For example, and not limitation, a portable master control unit according to the present disclosure may be used to control or walk several different loads, so that a load does not need a dedicated control unit. Additionally, by removing the various and numerous permanent control links, damage to and repair of the control links can be achieved thereby reducing downtime and expense and increasing safety. Additionally, by optimizing the size and location of the junction boxes on the load, physical damage to the junction boxes, such as from impacts and pressure washing are reduced. Still further, by providing each load with a unique ID, the portable master control unit can be programmed with the data specific to the control and transducing components actually used on the load. Other and further benefits are readily discernible from the above disclosure.

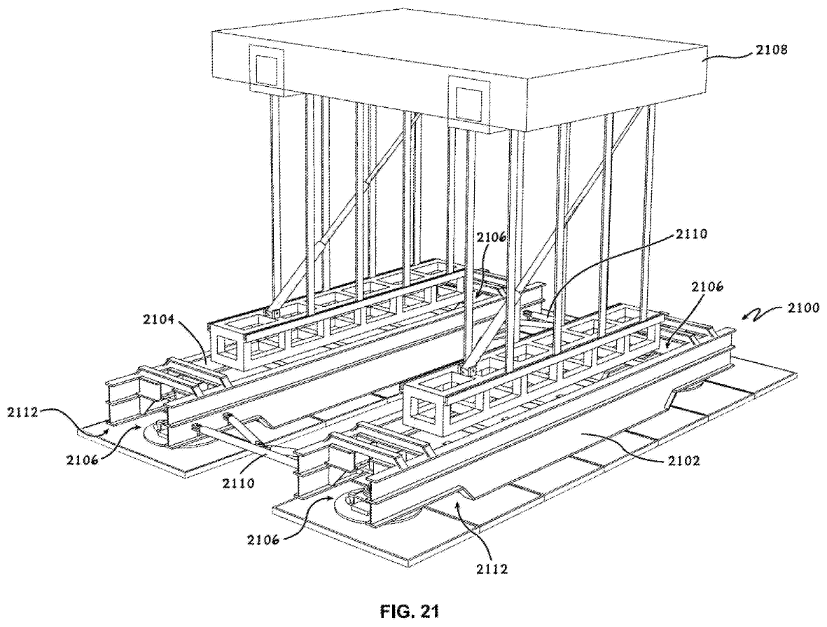

Turning now to FIG. 21, a walking system substructure 2100 or pony is disclosed. The pony 2100 comprises two substructures 2102 and 2104 connected together with removable K-brace trusses 2010. Each substructure comprises two walking systems 2106. A load 2108, such as a drilling rig, is shown operatively coupled to the substructures. Because it is typically important to maximize the space or width between the two substructure 2012, 2014, and also important to minimize the overall width of the pony 2100, the interior width of each substructure may be sacrificed. While a narrow width substructure may not affect a walking operation in a forward direction (i.e., along the longitudinal axis of the substructure), a narrow width may and often does restrict the length of step or stroke of walk at orientation off of axial. For example, a narrow width may restrict the length of step in a transverse direction compared to a length of step in the axial direction.

To overcome this problem, the substructures illustrated in FIG. 21 have step windows 2012 formed in both the inside surface and outside surface of the substructures 2102, 2104 adjacent each walking system 2106, and preferably adjacent each foot or shoe. It will be appreciated that the windows 2112 are sized and shaped to accommodate the shoe or foot in the load-bearing condition, and in at least a portion of the non-load bearing state. It will also be appreciated that the load bearing area (i.e., area between the load and the ground) of the substructure that is lost to the window may be offset by adding load bearing area to other portions of the substructure. For example, the length of the substructure's load bearing area may be increased to accommodate for the loss of area attributable to the windows. It will be appreciated that use of the windows 2122 allow the length of step in all directions to be the same.

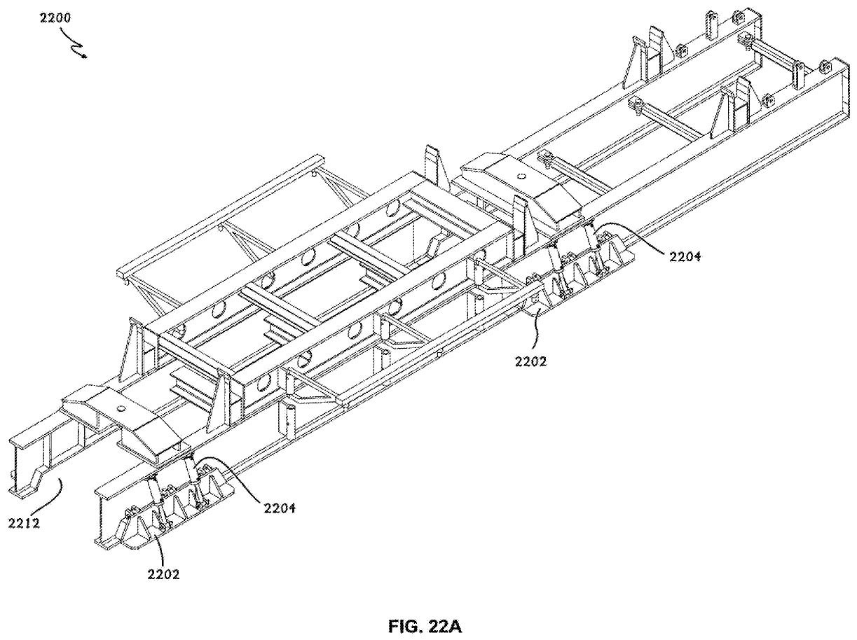

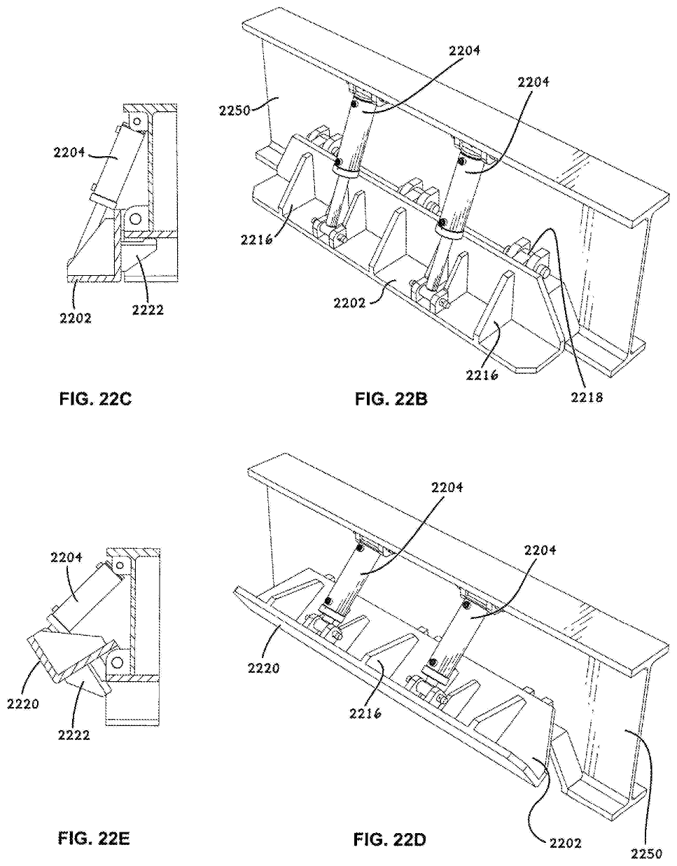

FIG. 22A-22E illustrate an alternate embodiment 2200 of the substructures shown in FIG. 21. FIG. 22A illustrate retractable outriggers 2202 deployed on all four windows 2212. It is preferred, but not required, that the load bearing of each outrigger is about equal to or greater than the load bearing area lost to the associated window. A hydraulic cylinder 2204 is illustrated as operatively coupled between the outrigger and the substructure frame and configured to retract and deploy the outrigger. It is preferred that when deployed the outrigger is locked in place, such as by pins. In use, the outriggers are unpinned when a walk is contemplated. When a walking operation is desired and the length of step would be restricted because of the substructure width and orientation of desired travel, the walking system control unit may send a signal to the hydraulic cylinder to retract from the load bearing condition, thereby opening the window. The walking operation may then proceed with the shoe or foot extending as necessary into and even out of the window 2212. In an alternate embodiment, the load is first lifted from the surface 2114 and the outriggers retracted whiled the load is lifted. The load is set back down on the surface, and the walking operation is commenced. Similarly, once the load is in position, the foot or shoe is returned to the null position, the load lifted, the outriggers deployed, and the load set back down on the substructure and outrigger load bearing areas. Also illustrated in FIG. 22A is a tracked foot 2208 (see also FIGS. 7A-7D). A tracked foot as described previously may reduce the size of the window, and therefore the size of the outriggers 2202.

FIGS. 22B-22E illustrate an outrigger embodiment formed from structural angle iron with reinforcement webs 2216 and with a plurality of cantilevered load arms 2222. The outrigger may be pin hinged 2218 to load frame or substructure frame 2250. FIGS. 22D and 22E show the outrigger in the retracted position which fully exposes the window 2212. The load bearing area 2220 of the outrigger can be seen. It will be appreciated that when in the load bearing state, the cantilevered load arms 2222 transfer the load to the frame 2250.

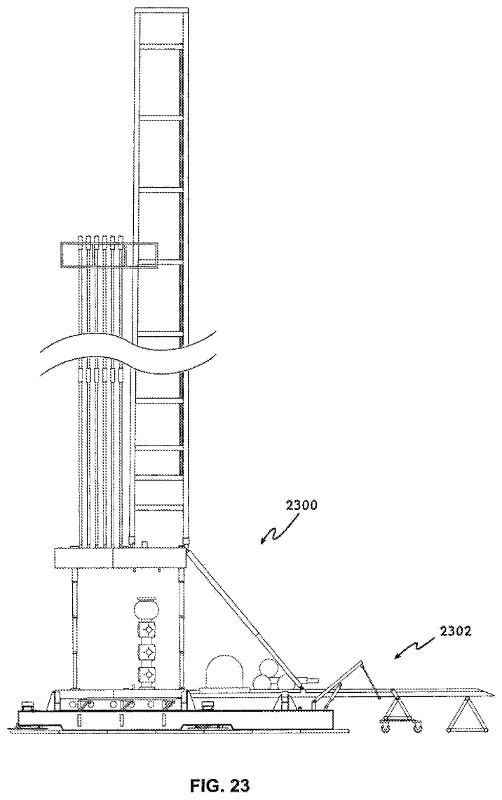

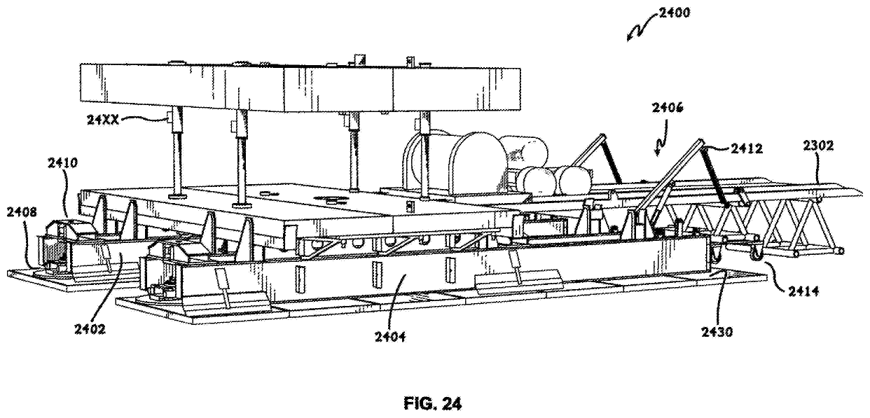

FIGS. 23 and 24 illustrate retrofitting a B Class drilling rig 2300 with mud boat 2302 a load transporting apparatus according to the present inventions. As illustrated in FIG. 24, a pony 2400 may comprise two substructures 2402 and 2404, which may be similar to the pony 2100 shown in FIG. 21. The pony 2400 is shown to have an extend portion 2406 (on both substructures) to help transport the mud boat 2302 and associated equipment. It can be seen that walking windows 2408, as previously disclosed, are preferred for this type of retrofit. The extended portion of the substructures is used to actively lift, such as through hydraulic cylinders 2410 and gin pole 2412, the mud boat 2302. An optional rolling support 2414 may be used as required based on the length and weight of the mud boat. The lift cylinders 2410 may be controlled by the master control unit, such as the portable master control unit described previously, such as by reenergizing lift cylinders 2410 when the walking system lift cylinders are energized during a lift. Because of the extended portion 2406 of the substructure, it is desirable to include removal bracing the extended portion to provide access the walking system.

Other and further embodiments utilizing one or more aspects of the inventions described above can be devised without departing from the spirit of Applicant's invention. Further, the various methods and embodiments of the methods of manufacture and assembly of the system, as well as location specifications, can be included in combination with each other to produce variations of the disclosed methods and embodiments. Discussion of singular elements can include plural elements and vice-versa.

The order of steps can occur in a variety of sequences unless otherwise specifically limited. The various steps described herein can be combined with other steps, interlineated with the stated steps, and/or split into multiple steps. Similarly, elements have been described functionally and can be embodied as separate components or can be combined into components having multiple functions.

The inventions have been described in the context of preferred and other embodiments and not every embodiment of the invention has been described. Obvious modifications and alterations to the described embodiments are available to those of ordinary skill in the art. The disclosed and undisclosed embodiments are not intended to limit or restrict the scope or applicability of the invention conceived of by the Applicants, but rather, in conformity with the patent laws, Applicants intend to protect fully all such modifications and improvements that come within the scope or range of equivalent of the following claims.

What is claimed is:

1. A control system for multiple load transporting apparatuses each having a plurality of walking systems, comprising:
a master control unit comprising signal processing and logic control circuits, and a plurality of bi-directional connectors operatively coupled thereto, the control unit operationally configured to select the number of active connectors for use with a load transporting apparatus;
a number of electrical cables corresponding to the number of active connectors, each cable configured to operatively connect the control unit to an associated junction box permanently associated with the load transporting apparatus;
the master control unit operationally configured to receive sensor signals from the plurality of walking systems, to provide control signals to the plurality of walking systems, and to provide power to the plurality of walking systems, across the number of cables;
the number of cables configured to be unconnected from the associated junction boxes when the load has been moved to the desired position, and the master control moved away from the load transporting apparatus to thereby eliminate the possibility of damage to the control unit and cables and to remove power from the plurality of walking systems.

2. The control system of claim 1, wherein the master control unit is portable and can be transported from one load transporting apparatus to another load transporting apparatus.

3. The control system of claim 2, wherein the master control unit operatively connected to the load transporting apparatus only when the load is being moved.

4. The control system of claim 2, wherein the master control unit comprises 6 bi-directional connectors.

5. The control system of claim 3, wherein the master control unit selects 2 active bi-directional connectors and 2 electrical cables operatively connect the master control unit to a load transporting apparatus.

6. The control system of claim 3, wherein the master control unit selects 4 active bi-directional connectors and 4 electrical cables operatively connect the master control unit to a load transporting apparatus.

7. The control system of claim 3, wherein the master control unit selects 6 active bi-directional connectors and 6 electrical cables operatively connect the master control unit to a load transporting apparatus.

8. A control system for a load transporting apparatus having a plurality of walking systems, comprising:
a master control unit comprising signal processing and logic control circuits, and a bi-directional wireless transceiver operationally configured to communicate with a number of bi-directional wireless transceivers operatively associated with the load transporting apparatus;
the master control unit operationally configured to wirelessly receive sensor signals about the plurality of walking systems from the bi-directional wireless transceivers, and to provide wireless control signals for the plurality of walking systems through the bi-directional wireless transceivers.

9. The control system of claim 10, wherein the master control unit is permanently attached to the load transporting apparatus.

10. The control system of claim 10, wherein the master control unit is portable and not permanently attached to the load transporting apparatus.

11. The control system of claim 10, wherein the master control unit is portable and is physically attached to the load transporting apparatus only when the load transporting system is used to move the load.

12. The control system of claim 10, wherein each of the plurality of walking systems has operatively associated therewith at least one junction box permanently attached to the load transporting apparatus, and a bi-directional wireless transceiver is operatively connected to the at least one junction box when it is desired to move the load.

13. The control system of claim 10, wherein each of bi-directional wireless transceiver has its own power supply.

14. The control system of claim 13, wherein the master control unit and bi-directional wireless transceivers are portable and are operatively connected to the load transporting apparatus only when load is being moved.
